(19) United States
(12) Patent Application Publication
(10) Pub. No.: US 2021/0146318 A1
(43) Pub. Date: May 20, 2021

(54) FINE BUBBLE GENERATION DEVICE AND FINE BUBBLE GENERATION METHOD

(71) Applicant: NGK SPARK PLUG CO., LTD., Nagoya-shi (JP)

(72) Inventor: Kazuteru HORIUCHI, Nagoya-shi (JP)

(73) Assignee: NGK SPARK PLUG CO., LTD., Nagoya-shi (JP)

(21) Appl. No.: 17/256,050

(22) PCT Filed: Jun. 28, 2019
(86) PCT No.: PCT/JP2019/025955

§ 371 Date: Dec. 24, 2020

(30) Foreign Application Priority Data
Jun. 28, 2018 (JP) 2018-123241

(51) Int. Cl. B01F 3/04; B01F 5/06; B01F 5/02

(52) U.S. Cl. CPC B01F 3/04751; B01F 3/04758; B01F 5/0692; B01F 2215/045; B01F 2215/0431; B01F 2215/0422; B01F 5/0287

(57) ABSTRACT

A fine bubble generation device in one aspect of the present disclosure is a device that generates fine bubbles in a liquid by causing the liquid to pass through a porous element having many pores. In the fine bubble generation device, a differential pressure is applied between first and second sides of the element, and, by the applied differential pressure, the liquid disposed on the first side of the element is passed through the element and is jetted toward the second side to thereby generate fine bubbles. In this fine bubble generation device, the flow speed of the liquid during passage through the element is 0.009769 [m/s] or higher. The fine bubbles can thereby be generated efficiently.

### CROSS REFERENCE TO RELATED APPLICATIONS

This application is a U.S. National Phase Application under 35 U.S.C. § 371 of international patent application PCT/JP2019/025955 filed on Jun. 28, 2019 and claims the benefit of priority to Japanese Patent Application No. 2018-filed with the Japanese Patent Office on Jun. 28, 2018, all of which are incorporated by reference in their entirety. The International Application was published in Japanese on Jan. 2, 2020 as International Publication No. WO/2020/004653 under PCT Article 21(2).

### FIELD OF THE INVENTION

The present disclosure relates to a fine bubble generation device and a fine bubble generation method for generating fine bubbles in a liquid.

### BACKGROUND OF THE INVENTION

The usefulness of a liquid containing very small bubbles called fine bubbles has recently been receiving attention. Specifically, attention has been given to a technique for a liquid (e.g., water) containing fine bubbles of various gases (i.e., a fine bubble liquid).

It has been contemplated to utilize the technique using such fine-bubble-containing liquid, for example, for washing of components etc., disinfection and deodorization of water, sterilization with ozone gas, health and medical fields, purification of water in lakes, ponds, and farms, treatment of wastewater from plants, stock farms, etc., growth promotion in agriculture and fishery, production of functional water such as hydrogen water, etc.

Known examples of the device that generates fine bubbles include devices of various types such as a pressurized dissolution type, a fine pore type, a static mixer type, and a spiral liquid flow type. In particular, devices of the fine pore type in which fine bubbles are generated using a porous material have recently been proposed (see Japanese Patent Application Laid-Open (kokai) No. 2017-170278 and Japanese Patent Application Laid-Open (kokai) No. 2017-47374) because of their advantages such as a simple structure.

For example, Japanese Patent Application Laid-Open (kokai) No. 2017-170278 discloses a technique in which a liquid is caused to flow inside a porous pipe (i.e., through through-holes) and a high-pressure gas is supplied to the outer side of the porous pipe to generate fine bubbles in the liquid in the porous pipe.

Japanese Patent Application Laid-Open (kokai) No. 2017-47374 discloses a technique in which a porous pipe is submerged in a liquid and a high-pressure gas is supplied to the porous pipe to generate fine bubbles in the liquid on the outer side of the porous pipe.

Various techniques regarding fine bubble other than the above techniques have been proposed (see Japanese Patent Application Laid-Open (kokai) No. 2002-301345 and Japanese Patent Application Laid-Open (kokai) No. 2017-217585). For example, Japanese Patent Application Laid-Open (kokai) No. 2002-301345 and Japanese Patent Application Laid-Open (kokai) No. 2017-217585 disclose a technique in which a porous member formed of a resin or a metal is used to reduce the size of bubbles contained in water in a pre-stage tank. In this technique, large air bubbles contained in the water in the pre-stage tank are sheared (i.e., the air bubbles are cut finely into bubbles having smaller diameters), to thereby produce fine bubbles.

### PRIOR ART DOCUMENTS

### Patent Documents

Japanese Patent Application Laid-Open (kokai) No. 2017-170278
Japanese Patent Application Laid-Open (kokai) No. 2017-47374
Japanese Patent Application Laid-Open (kokai) No. 2002-301345
Japanese Patent Application Laid-Open (kokai) No. 2017-217585

### Problems to be Solved by the Invention

In the techniques described in Japanese Patent Application Laid-Open (kokai) No. 2017-170278 and Japanese Patent Application Laid-Open (kokai) No. 2017-47374, fine bubbles are generated in a liquid in the following manner. The liquid is placed inside a porous pipe, and a high-pressure gas is supplied from the outer side of the porous pipe. Alternatively, the liquid is placed on the outer side of a porous pipe, and a high-pressure gas is supplied from the inner side of the porous pipe. However, a problem with these techniques is that fine bubbles cannot be generated efficiently.

For example, one problem with the conventional techniques is that the amount of generatable fine bubbles is small as compared with the amount of the high-pressure gas (gas amount) mixed into the liquid to generate the fine bubbles.

In the techniques described in Japanese Patent Application Laid-Open (kokai) No. 2002-301345 and Japanese Patent Application Laid-Open (kokai) No. 2017-217585, it is necessary to shear bubbles in the pre-stage tank. This is not preferable because the device structure and the operating process are complicated.

In one aspect of the present disclosure, it is preferable to provide a fine bubble generation device and a fine bubble generation method that can generate fine bubbles in a liquid efficiently.

### SUMMARY OF THE INVENTION

### Means for Solving the Problems

(1) A fine bubble generation device in one aspect of the present disclosure relates to a fine bubble generation device that generates fine bubbles in a liquid by causing the liquid to pass through a porous element having many pores. The fine bubble generation device includes a differential pressure applying section and a bubble generating section.

In this fine bubble generation device, the differential pressure applying section applies a differential pressure between first and second sides of the element. The bubble generating section is configured such that, by the differential pressure applied by the differential pressure applying section, the liquid disposed on the first side of the element is passed through the element and is jetted toward the second side to thereby generate fine bubbles. When the fine bubbles are generated, the flow speed of the liquid during passage through the element is 0.009769 [m/s] or higher.

The upper limit of the flow speed may be 1500 [m/s].

First, the reason why the flow speed in the fine bubble generation device is specified to be 0.009769 [m/s] or higher will be described.

In recent years, there is a movement of standardization of fine bubble water. Specifically, “fine bubble water is defined as water prepared by subjecting pure water (blank water) to fine bubble generation treatment to increase the concentration of bubbles by at least one order of magnitude” (the standardization is discussed in FBIA (Fine Bubble Industries Association)).

As for the bubble concentration of pure water (blank water) used for experiments described later (i.e., the bubble concentration of the pure water before the generation of fine bubbles), Max (the maximum value) is 2.98 E+06 [bubbles/mL], and Ave (the average value) is 1.22 E+06 [bubbles/mL], as can be seen from Table 8 described later. Notably, for example, E+06 means 10⁶ and, as is well known, is exponent notation representing the exponent of 10.

Therefore, in this fine bubble generation device, 6.82 E+07 [bubbles/mL] is determined as a reference value for increasing the bubble concentration by at least one order of magnitude, and a flow speed necessary to obtain a bubble concentration higher than the reference value is specified. The specified flow speed enables efficient generation of fine bubbles.

As described above, in the first aspect, since the liquid passes through the porous element at a flow speed of 0.009769 [m/s] or higher due to the differential pressure applied by, for example, a gas, fine bubbles can be generated efficiently as described later in Experimental Examples.

Namely, a liquid with a high bubble concentration (i.e., a fine bubble liquid) can be easily produced without mixing a gas into the liquid under high pressure as in the conventional techniques. Even in the case of, for example, pure water, the bubble concentration can be easily increased.

In this fine bubble generation device, fine bubbles can be generated efficiently, by causing the liquid disposed on the first side of the element to pass through the element and be jetted toward the second side; i.e., by passing the liquid through the element at least one time.

As described above, in this fine bubble generation device, the flow speed of the liquid during passage through the fine pores in the porous element is equal to or higher than the prescribed value. This enables efficient generation of fine bubbles. Therefore, fine bubbles can be easily generated using a small device without using a conventional facility provided with a large pump, etc. For example, when the differential pressure is generated using a gas supplied from a gas cylinder, a pump, a power supply, etc. can be omitted.

The following reason is presumed as the reason why fine bubbles can be generated efficiently by specifying the flow speed in the manner described above.

Presumably, when a liquid passes though pores (i.e., very small regions) in the porous element at a high flow speed, cavitation occurs locally in the pores. The cavitation causes rapid energy changes such as changes in pressure and changes in amount of heat. As a result, many bubble nuclei (i.e., seeds of fine bubbles) are generated, and many fine bubbles are generated from the bubble nuclei.

(2) In the above-described fine bubble generation device, the element may have an average pore diameter of 1.5 μm to 500 μm.

By using the element having the above average pore diameter, fine bubbles can be generated efficiently, as will be clear from the Experimental Examples described later. Moreover, a high bubble concentration can be achieved.

(3) In the above-described fine bubble generation device, the element may have a surface porosity of 24% to 47.7%.

By using the element having the above surface porosity, fine bubbles can be generated efficiently, as will be clear from the Experimental Examples described later. Moreover, a high bubble concentration can be achieved.

(4) In the above-described fine bubble generation device, the contact angle of the liquid on a surface of the element may be 38.8° to 151.32°.

By using the element having the above liquid contact angle, fine bubbles can be generated efficiently, as will be clear from the Experimental Examples described later. Moreover, a high bubble concentration can be achieved.

(5) In the above-described fine bubble generation device, the element may be formed of a ceramic.

The element formed of a ceramic as described above is preferable because the amount of impurities (i.e., contamination) contained in the liquid in which the fine bubbles are generated is small. When the fine bubble generation device is used in, for example, the medical field, the food field, etc., it is preferable that the amount of impurities is small. Therefore, it is preferable to use the ceramic-made element in these fields.

Another advantage of the ceramic-made element is that deterioration due to erosion is small.

(6) The above-described fine bubble generation device may further comprise a first tank formed integrally with the element, and a second tank that receives the liquid jetted from the element.

By using the device described above, the liquid containing fine bubbles can be easily produced. In this device, the liquid is placed in the first tank and supplied from the first tank to the first side of the element. The liquid is jetted toward the second side to thereby generate fine bubbles, and the liquid containing the fine bubbles can be received by the second tank.

(7) In the above-described fine bubble generation device, the first tank may have a gas supply section serving as the differential pressure applying section so as to supply a gas to the first tank, the gas applying the differential pressure, and a liquid supply section for supplying the liquid to the first tank. Notably, the gas supply section is an example of the differential pressure applying section.

In this fine bubble generation device, the gas that applies the differential pressure can be supplied to the first tank using the gas supply section of the first tank, and the liquid can be supplied to the first tank using the liquid supply section of the first tank.

(8) In the above-described fine bubble generation device, the second tank may have a liquid withdrawing section for withdrawing the jetted liquid to the outside.

In this fine bubble generation device, the jetted liquid can be withdrawn to the outside using the liquid withdrawing section of the second tank.

(9) A fine bubble generation method in another aspect of the present disclosure relates to a fine bubble generation method for generating fine bubbles in a liquid by causing the liquid to pass through a porous element having many pores.

In this fine bubble generation method, by applying the differential pressure between the first and second sides of the element, the liquid disposed on the first side of the element is passed through the element and is jetted toward the second side to thereby generate fine bubbles. For generation of the fine bubbles, the flow speed of the liquid during passage through the element is set to 0.009769 [m/s] or higher.

The fine bubble generation method has the same effects as those of the above fine bubble generation device.

### <The Structure of the Present Disclosure Will Next be Described>

The porous element is a porous member having many pores formed therein (i.e., communicating holes through which the liquid can pass). Examples of this element include a tubular member through which the liquid can pass from the inner side to the outer side or from the outer side to the inner side, a tubular member having a closed forward end, and a tubular member having opposite open ends. Other examples include a film-shaped (e.g., plate-shaped) member through which the liquid can pass from one side to the other side.
Examples of the material of the element include materials formed of a ceramic (for example, at least one of alumina, mullite, zirconia, titania, silica, magnesia, and calcia), various resins (such as polyethylene, polypropylene, polyethylene terephthalate, and polytetrafluoroethylene), and metals (such as aluminum, titanium, iron, gold, silver, copper, stainless steel). For example, a sintered product containing 97% by weight of alumina may be used for the element. In particular, the material of the element is preferably a material formed of any of the above ceramics.
The liquid used may be water (such as pure water, tap water, or deionized water), alcohol, seawater, an aqueous solution, a cleaning fluid, an organic solvent, etc. Generally, a small amount of various gasses such as an ambient gas are dissolved in the liquid.
The fine bubbles are bubbles having a diameter of 100 μm (10⁻⁴ m) or less as defined by the International Organization for Standardization (ISO) and include micro-bubbles having a diameter of 1 μm or more and less than 100 μm and ultra-fine bubbles having a diameter of less than 1 μm. Examples of the gas contained in the fine bubbles include various gases such as hydrogen, oxygen, carbon dioxide, and air.
Examples of the method for setting the flow speed to the above range include a method in which the differential pressure applied to the liquid in which fine bubbles are to be generated is adjusted. For example, the flow speed can be increased by increasing the differential pressure by increasing the pressure applied to the liquid before it passes through the element.

Examples of the method for applying the differential pressure include a method in which the pressure applied to the first side (liquid side) of the element is increased by, for example, supplying a high-pressure gas (i.e., a method in which the atmospheric pressure is increased). For example, the differential pressure can be applied using a gas supplied from a gas cylinder. Another example of the method for applying the differential pressure is reducing by, for example, evacuation, the pressure (e.g., atmospheric pressure) applied to the second side of the element (the side on which fine bubbles are generated).
The flow speed [m/s] can be determined, for example, by computing Q/S using the flow rate (Q [m³/s]) of the liquid flowing from the first side (liquid side) of the element to the second side (the side on which fine bubbles are generated) and the total area (S [m²]) of opening portions (i.e., pore portions) of the surface on the second side of the element. The maximum value of the flow speed is 1500 m/s, which is the maximum transmission speed of ultrasonic waves generated in water.
The surface porosity of the element is the ratio of the total area of the opening portions (pore portions) of the surface of the element on the second side (the side on which fine bubbles are generated) to the total surface area of the element on the second side.

### BRIEF DESCRIPTION OF THE DRAWINGS

FIG. 1 is an illustration showing a fine bubble generation device of a first embodiment.

FIG. 2 is a graph showing the relation between gas consumption and bubble concentration in the fine bubble generation device of the first embodiment and in a conventional fine pore-type device.

FIG. 3 is an illustration showing a fine bubble generation device of a second embodiment.

FIG. 4 is an illustration showing a fine bubble generation device of a third embodiment.

FIG. 5 is an illustration showing a fine bubble generation device of a fourth embodiment.

FIG. 6 is an illustration showing an element used in Experimental Example 1 and names of dimensions of the element.

FIG. 7A is a graph showing the characteristics of liquids of samples in Experimental Example 4, specifically, their pH values; FIG. 7B is a graph showing the characteristics of the liquids of the samples in Experimental Example 4, specifically, their electric conductivities; and FIG. 7C is a graph showing the characteristics of the liquids of the samples in Experimental Example 4, specifically, their ATP values.

FIG. 8A is a graph showing the characteristics of the liquids of the samples in Experimental Example 4, specifically, their TOC values, and FIG. 8B is a graph showing the characteristics of the liquids of the samples in Experimental Example 4, specifically, their ICP-MS values.

FIG. 9A is a graph showing the characteristics of liquids of samples in Experimental Example 5, specifically, their particle concentrations before and after freezing, and FIG. 9B is a graph showing the characteristics of the liquids of the samples in Experimental Example 5, specifically, their particle concentrations with the concentrations before defoaming set to 100.

### DESCRIPTION OF REFERENCE NUMERALS

1, 71, 91, 101 fine bubble generation device
3, 103 first tank
5, 105 second tank
9 gas supply section
10 differential pressure applying section
11 liquid supply section
13 liquid withdrawing section
31 bubble generating section
33, 75, 97, 107 element

### DETAILED DESCRIPTION OF THE INVENTION

Embodiments of a fine bubble generation device and a fine bubble generation method to which the present disclosure is applied will be described with reference to the drawings.

### 1. FIRST EMBODIMENT

### 1-1. Overall Structure

The structure of a fine bubble generation device of a first embodiment will be described.

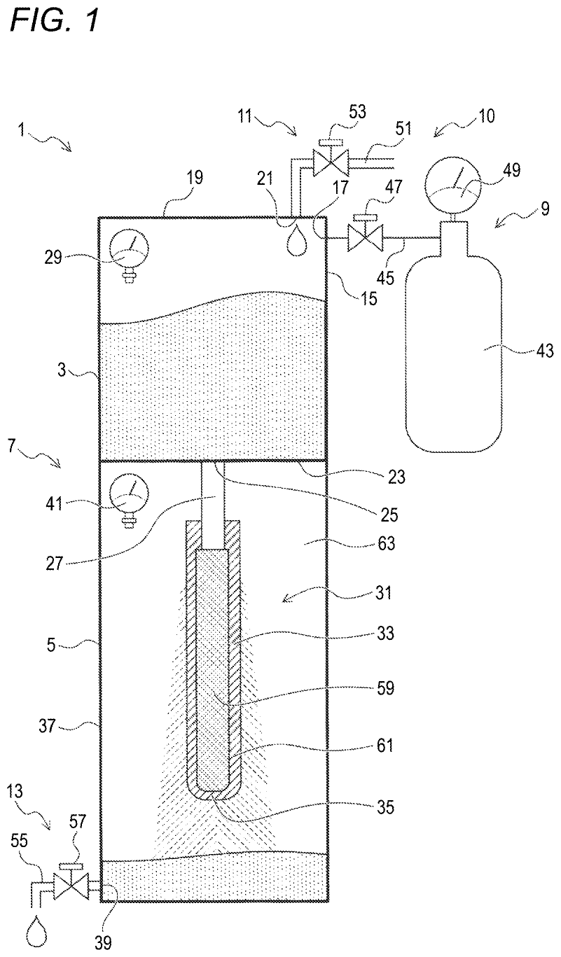

As shown in FIG. 1, the fine bubble generation device 1 of the first embodiment is a device that generates fine bubbles in a liquid (water such as pure water) and includes a box-shaped device body 7 including a first tank 3 and a second tank 5; a gas supply section 9 that supplies a gas (e.g., nitrogen gas) to the first tank 3; a liquid supply section 11 that supplies the liquid to the first tank 3; and a liquid withdrawing section 13 that withdraws the liquid (i.e., the liquid containing fine bubbles generated therein: fine bubble liquid) from the second tank. The details will be described below.

### <First Tank>

The first tank 3 is a container that can store the liquid and is configured such that its interior can be pressurized. Specifically, the first tank 3 has an airtight structure for preventing the liquid and the gas from flowing out, except portions through which the liquid is supplied and flows out and a portion through which the gas flows into the first tank 3.

A gas introduction port 17 for introducing the gas supplied from the gas supply section 9 into the first tank 3 is provided in a side wall 15 thereof, and a liquid introduction port 21 for introducing a liquid supplied from the liquid supply section 11 is provided in an upper portion 19 of the first tank 3. Notably, the gas introduction port 17 is disposed at a position that is above the level of the liquid placed in the first tank 3.

A liquid supply port 25 for supplying the liquid to the second tank 5 side is provided at a bottom 23 of the first tank 3, and a stainless steel-made cylindrical communication pipe 27 extending vertically downward is attached to the liquid supply port 25 such that a space on the first tank 3 side and a space on the second tank 5 side are in communication with each other. The liquid in the first tank 3 is supplied to the second tank 5 side through the communication pipe 27.

Moreover, a first pressure sensor 29 for detecting the pressure (air pressure) inside the first tank 3 is disposed in the first tank 3.

The first tank 3 having the airtight structure and the gas supply section 9 form a structure for applying a differential pressure (i.e., a differential pressure applying section 10).

### <Second Tank>

The second tank 5 is a container capable of containing a liquid (i.e., the fine bubble liquid) and includes a bubble generating section 31 disposed therein and configured to generate fine bubbles.

The bubble generating section 31 includes the communication pipe 27 and a porous element 33 connected to the lower end of the communication pipe 27. Therefore, the element 33 is integrated with the first tank 3 through the communication pipe 27.

The element 33 is a pipe-shaped (specifically, a circular cylindrical) member having a closed lower end (i.e., a forward end), and the upper end of the element 33 is fitted onto the communication pipe 27, joined to the communication pipe 27 using an adhesive and a metal joint (not shown), and is in contact with the communication pipe 27 with no gap therebetween. The lower end of the element 33 is closed by a bottom 35 that is part of the element 33.

The element 33 is a porous sintered body containing, for example, alumina (Al₂O₃), which is a ceramic, as a main component (e.g., 97% by weight of alumina) and 3% by weight of a ceramic such as silica (SiO₂), calcia (CaO), or magnesia (MgO) as the remainder. Many pores (i.e., communication pores through which the liquid can pass) are formed over the entire sintered body. Namely, the element 33 is a ceramic porous sintered body. The sintered body has a single layer structure (i.e., a symmetric structure) in which many pores are present in the same state (e.g., having the same average pore diameter).

Specifically, the average pore diameter of the element 33 is within the range of 1.5 μm to 500 μm, and the surface porosity of the element 33 is within the range of 24% to 47.7%. The contact angle of the liquid (e.g., water) on the surface of the element 33 is within the range of 38.8° to 151.32°.

A liquid withdrawing port 39 for withdrawing the liquid from the second tank 5 to the outside is disposed in a lower portion of a side wall 37 of the second tank 5, and the liquid withdrawing section 13 is connected to the liquid withdrawing port 39.

Further, a second pressure sensor 41 for detecting the pressure (air pressure) inside the second tank 5 is disposed in the second tank 5.

### <Peripheral Structure>

The gas supply section 9 includes a gas cylinder 43 filled with a gas, a first pipe 45 connecting the gas cylinder 43 to the gas introduction port 17, a first on-off valve 47 for opening and closing the flow channel of the first pipe 45, and a third pressure sensor 49 for detecting the pressure inside the gas cylinder 43.

The liquid supply section 11 includes a second pipe 51 connected to the liquid introduction port 21 to supply the liquid to the first tank 3 and a second on-off valve 53 for opening and closing the flow channel of the second pipe 51. Although not illustrated, a tank or the like for storing the liquid is disposed on the upstream side of the second pipe 51.

The liquid withdrawing section 13 includes a third pipe 55 connected to the liquid withdrawing port 39 to withdraw the liquid to the outside and a third on-off valve 57 for opening and closing the flow channel of the third pipe 55.

### 1-2. Operation of Fine Bubble Generation Device

Next, the operation of the fine bubble generation device 1 will be described.

First, with the first on-off valve 47 and the third on-off valve 57 closed, the second on-off valve 53 is opened to supply a prescribed amount (e.g., VO [mL]) of the liquid from the second pipe 51 to the first tank 3. Then, the second on-off valve 53 is closed. In this case, the liquid in the first tank 3 flows through the communication pipe 27 into the element 33 (i.e., flows into an inner space 59).

Next, the first on-off valve 47 is opened to supply a high-pressure gas from the gas cylinder 43 into the first tank 3. As a result, the pressure inside the first tank 3 becomes higher than, for example, the atmospheric pressure (e.g., 0.4 MPa).

When the pressure inside the first tank 3 increases as described above, the liquid in the first tank 3 is pressurized, and the liquid in the element 33 is also pressurized.

When the liquid inside the element 33 is pressurized, the liquid inside the element 33 passes through the pores on a wall surface 61 of the element 33 and is jetted at high speed to the outside of the element 33 (i.e., an outer space 63 in the second tank).

In this case, the flow speed of the liquid during passage through the element 33 is 0.009769 m/s or higher. When the liquid passes through the element 33 at such a high speed, many fine bubbles are generated. Specifically, a fine bubble liquid containing the fine bubbles is obtained.

### 1-3. Method for Producing Element

A method for producing the element 33 will be described. Since the element 33 can be produced by a routine method, the method will be described briefly.

For example, 97% by weight of alumina powder having an average particle size of 5 μm and 3% by weight of sintering aid powder such as SiO₂ or MgO powder were prepared as solid materials for the element 33.

Then, methyl cellulose, water, and a release agent were added to these solid powders to produce kneaded clay, and a closed-end cylindrical compact was formed using the kneaded clay.

Then the compact was dried and fired at 1500° C. in an air atmosphere for 3 hours to thereby obtain the element 33 having the above-described structure.

As is well known, the average pore diameter can be adjusted by controlling the particle diameters of the raw material powders. As is well known, the surface porosity can be adjusted by controlling the amount of the solid powders, the amount of the organic material, and the amount of water.

### 1-4. Effects

(1) In the first embodiment, since the differential pressure applied by the gas causes the liquid to pass through the porous element 33 at a flow speed of 0.009769 [m/s] or higher, fine bubbles can be efficiently generated.

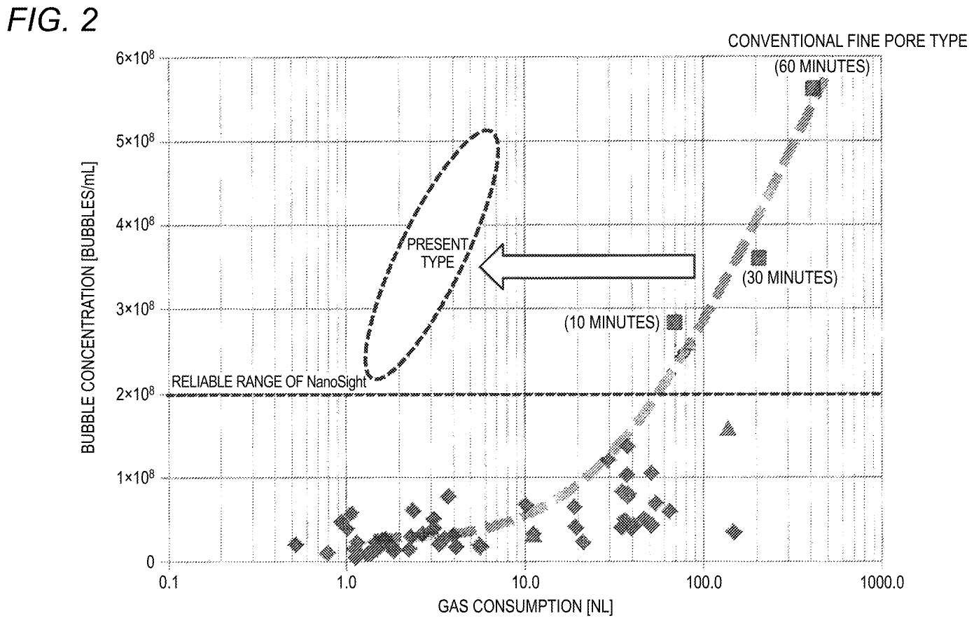

For example, as shown in FIG. 2, in a conventional fine pore-type device (a device available from company C described later), the bubble concentration increases as the gas consumption increases. In the fine bubble generation device 1 of the first embodiment (i.e., the present type), a high bubble concentration can be obtained with less gas consumption than that of the fine pore-type device. The gas consumption in the present type in FIG. 2 is the consumption of the gas used for pressurization.

Specifically, a liquid having a high bubble concentration (i.e., a fine bubble liquid) can be easily produced without mixing a gas into a liquid under high pressure as in the conventional device. For example, even in the case of pure water, the bubble concentration can be easily increased.

(2) In the first embodiment, fine bubbles can be generated efficiently by causing the liquid disposed on the first side of the element 33 to pass through the element 33 and be jetted toward the second side; i.e., by passing the liquid through the element 33 at least one time (hereinafter referred to as “one pass”).

(3) As descried above, in the first embodiment, fine bubbles are generated efficiently by setting the flow speed of the liquid during passage through the pores of the porous element 33 to a prescribed value or greater. Therefore, fine bubbles can be easily generated without using a conventional facility provided with a large pump etc., i.e., by using a small device. Specifically, by generating a differential pressure using the gas supplied from the gas cylinder 43, the pump, a power supply, etc., can be omitted.

(4) In the first embodiment, the average pore diameter of the element 33 is within the range of 1.5 μm to 500 μm. Therefore, fine bubbles can be generated efficiently. Moreover, a high bubble concentration can be achieved.

(5) In the first embodiment, the surface porosity of the element is within the range of 24% to 47.7%. Therefore, fine bubbles can be generated efficiently. Moreover, a high bubble concentration can be achieved.

(6) In the first embodiment, the contact angle of the liquid on the surface of the element 33 is within the range of 38.8° to 151.32°. Therefore, fine bubbles can be generated efficiently. Moreover, a high bubble concentration can be achieved.

(7) In the first embodiment, the element 33 is formed of a material containing a ceramic as a main component. Therefore, the amount of impurities (i.e., contamination) contained in the liquid in which the fine bubbles are generated is small, so that the element 33 is suitable for a field that prefers less impurities such as the medical field.

When the element 33 contains a ceramic as a main component, there is also an advantage in that deterioration due to erosion is small.

### 1-5. Correspondence Between Terms

The fine bubble generation device 1, the first tank 3, the second tank 5, the gas supply section 9, the differential pressure applying section 10, the liquid supply section 11, the liquid withdrawing section 13, the bubble generating section 31, the element 33 in the first embodiment correspond to examples of the fine bubble generation device, the first tank, the second tank, the gas supply section, the differential pressure applying section, the liquid supply section, the liquid withdrawing section, the bubble generating section, the element, respectively, in the present disclosure.

### 2. SECOND EMBODIMENT

Next, a second embodiment will be described, but description of the same details as those in the first embodiment will be omitted or simplified.

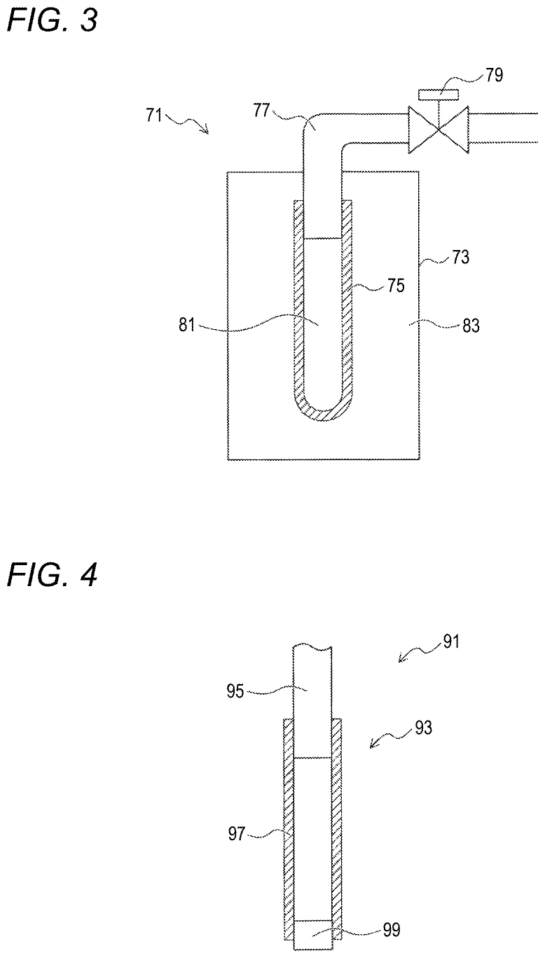

As shown in FIG. 3, in a fine bubble generation device 71 of the second embodiment, an element 75 similar to that in the first embodiment is disposed in a single tank 73, and a communication pipe 77 is connected to the upper end of the element 75.

The communication pipe 77 extends to the outside of the tank 73, and an on-off valve 79 is disposed in the communication pipe 77 on the outer side of the tank 73.

In the second embodiment, by opening the on-off valve 79, a liquid (e.g., water) to which a prescribed pressure is applied is supplied from the communication pipe 77 to the interior of the element 75 (i.e., an inner space 81). Thus, fine bubbles can be generated in the liquid, as in the first embodiment. Notably, the fine bubble liquid can be supplied to an outer space 83 around the element 75.

The structure for withdrawing the fine bubble liquid from the tank 73 is the same as that in the first embodiment.

The effects of the second embodiment are the same as those of the first embodiment. An advantage of the second embodiment is that the structure can be simpler than that in the first embodiment.

### 3. THIRD EMBODIMENT

Next, a third embodiment will be described, but description of the same details as those in the first embodiment will be omitted or simplified.

The third embodiment is the same as the first embodiment except for the structure of the bubble generating section, and therefore the bubble generating section will be described.

As shown in FIG. 4, the bubble generating section 93 of a fine bubble generation device 91 of the third embodiment is formed by connecting a cylindrical tubular element 97 to the lower end of a communication pipe 95.

The element 97 is open at opposite ends in its axial direction (in the vertical direction in FIG. 4). The upper end is connected to the communication pipe 95, and the lower end is closed with a cap 99. The cap 99 has a circular columnar shape and is a dense sintered body formed of, for example, alumina.

The third embodiment has the same effects as those of the first embodiment.

### 4. FOURTH EMBODIMENT

Next, a fourth embodiment will be described, but description of the same details as those in the first embodiment will be omitted or simplified.

In the fourth embodiment, the element used is a plate-shaped member.

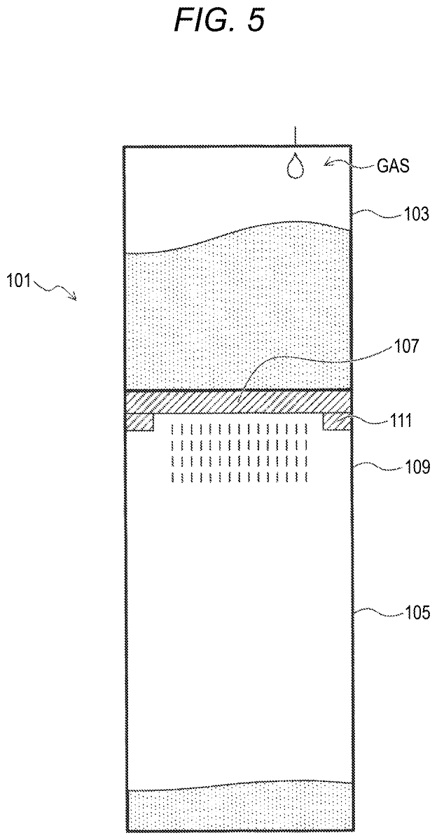

As shown in FIG. 5, a fine bubble generation device 101 of the fourth embodiment has a structure in which a second tank 105 is disposed below a first tank 103, as in the first embodiment.

A flat plate-shaped element 107 is disposed horizontally between the first tank 103 and the second tank 105 so as to separate the first tank 103 and the second tank 105 from each other. The element 107 is positioned and fixed by a support member 111 disposed on a side wall 109.

In FIG. 5, other structures (e.g., structures for supplying gas and liquid to the first tank 103) are omitted.

In the fourth embodiment also, by supplying liquid to the first tank 103 and supplying gas to pressurize the liquid, the liquid is caused to pass through the element 107, and fine bubbles can thereby be generated in the liquid. Namely, a fine bubble liquid can be supplied to the second tank 105 below the element 107.

The structure for withdrawing the fine bubble liquid from the second tank 105 is the same as that in the first embodiment.

The fourth embodiment has the same effects as those in the first embodiment.

### 5. EXPERIMENTAL EXAMPLES

Experimental Examples conducted to examine the effects of the present disclosure will be described. The liquid used was pure water.

### 5-1. Experimental Example 1

### <Details of Experiment>

In Experimental Example 1, as a device for generating fine bubbles, there was used a fine bubble generation device having the same structure as that in the first embodiment in which elements similar to that in the third embodiment were used.

Sixty one samples (samples Nos. 1 to 59) shown in Tables 1 to 6 were produced as elements used for the experiment. In Tables 1 to 6, samples of Examples (Examples 1 to 32) are within the scope of the present disclosure, and samples of Comparative Examples (Comparative Examples 1 to 27) are outside the scope of the present disclosure.

In Tables 1 and 2, the Examples and the Comparative Examples are shown in ascending order of sample number. In Tables 3 and 4, only the Examples are shown. In Tables 5 and 6, only the Comparative Examples are shown.

In Experimental Example 1, fine bubbles were generated under the conditions shown in Tables 1 to 6 below, and the flow speed of liquid during passage through each element, etc. were determined as shown in Tables 2, 4, and 6 below.

Table 7 shows a plurality of Comparative Examples and a plurality of Examples selected as examples from the samples described in Tables 1 to 6. In Table 7, each preferable sample realizing a bubble concentration of 6.82 E+0.7 or more is determined to be “acceptable,” and each of the remaining unpreferable samples is determined to be “unacceptable.”

The experimental conditions and the experimental results shown in Tables 1 to 7 will be described.

TABLE 1

| | | Element data | | | | | | | | | |
|---|---|---|---|---|---|---|---|---|---|---|---|
| | | | | | Bubble point | Effective | | | Element | | |
| | | | | Contact | pressure | area of | Surface | Pore | outer | Element | Film |
| | | Element | Element | angle | (pure water) | element | porosity | diameter | diameter | length | thickness |
| | No. | structure | material | [°] | [MPaG] | [mm²] | [%] | [nm] | [mm] | [mm] | [mm] |
| Ex. 1 | 1 | Symmetric | Alumina | 43.55 | 0.1406 | 3240 | 31 | 1500 | 12 | 270 | 1.5 |
| Ex. 2 | 2 | Symmetric | Alumina | 43.55 | 0.1406 | 3240 | 31 | 1500 | 12 | 270 | 1.5 |
| Ex. 3 | 3 | Symmetric | Alumina | 43.55 | 0.1406 | 3240 | 31 | 1500 | 12 | 270 | 1.5 |
| Comp. Ex. 1 | 4 | Asymmetric | Alumina | 31.4 | 3.1048 | 3240 | 42 | 80 | 12 | 270 | 1.5 |
| Comp. Ex. 2 | 5 | Asymmetric | Alumina | 31.4 | 3.1048 | 3240 | 42 | 80 | 12 | 270 | 1.5 |
| Ex. 4 | 6 | Symmetric | Alumina | 43.81 | 0.0210 | 3240 | 24 | 10000 | 20 | 300 | 4 |
| Ex. 5 | 7 | Symmetric | Alumina | 43.81 | 0.0210 | 6000 | 24 | 10000 | 20 | 300 | 4 |
| Ex. 6 | 8 | Symmetric | Alumina | 43.81 | 0.0210 | 6000 | 24 | 10000 | 20 | 300 | 4 |
| Ex. 7 | 9 | Symmetric | Alumina | 49.23 | 0.0127 | 6000 | 24 | 15000 | 20 | 300 | 4 |
| Ex. 8 | 10 | Symmetric | Alumina | 49.23 | 0.0127 | 6000 | 24 | 15000 | 20 | 300 | 4 |
| Ex. 9 | 11 | Symmetric | Alumina | 49.23 | 0.0127 | 6000 | 24 | 15000 | 20 | 300 | 4 |
| Comp. Ex. 3 | 12 | Asymmetric | Alumina | 109.08 | −1.1891 | 3240 | 42 | 80 | 12 | 270 | 1.5 |
| Comp. Ex. 4 | 13 | Asymmetric | Alumina | 109.08 | −1.1891 | 3240 | 42 | 80 | 12 | 270 | 1.5 |
| Comp. Ex. 5 | 14 | Asymmetric | Alumina | 109.08 | −1.1891 | 3240 | 42 | 80 | 12 | 270 | 1.5 |
| Comp. Ex. 6 | 15 | Asymmetric | Alumina | 123.6 | −2.0130 | 3240 | 42 | 80 | 12 | 270 | 1.5 |
| Comp. Ex. 7 | 16 | Asymmetric | Alumina | 123.6 | −2.0130 | 3240 | 42 | 80 | 12 | 270 | 1.5 |
| Comp. Ex. 8 | 17 | Asymmetric | Alumina | 123.6 | −2.0130 | 3240 | 42 | 80 | 12 | 270 | 1.5 |
| Comp. Ex. 9 | 18 | Asymmetric | Alumina | 37.05 | 1.1613 | 3240 | 55 | 200 | 12 | 270 | 1.5 |
| Comp. Ex. 10 | 19 | Asymmetric | Alumina | 37.05 | 1.1613 | 3240 | 55 | 200 | 12 | 270 | 1.5 |
| Comp. Ex. 11 | 20 | Asymmetric | Alumina | 37.05 | 1.1613 | 3240 | 55 | 200 | 12 | 270 | 1.5 |
| Comp. Ex. 12 | 21 | Asymmetric | Alumina | 40.15 | 0.5561 | 3240 | 55 | 400 | 12 | 270 | 1.5 |
| Comp. Ex. 13 | 22 | Asymmetric | Alumina | 40.15 | 0.5561 | 3240 | 55 | 400 | 12 | 270 | 1.5 |
| Comp. Ex. 14 | 23 | Asymmetric | Alumina | 40.15 | 0.5561 | 3240 | 55 | 400 | 12 | 270 | 1.5 |
| Comp. Ex. 15 | 24 | Symmetric | Alumina | 87.53 | 0.0084 | 3240 | 31 | 1500 | 12 | 270 | 1.5 |
| Ex. 10 | 25 | Symmetric | Alumina | 87.53 | 0.0084 | 3240 | 31 | 1500 | 12 | 270 | 1.5 |
| Ex. 11 | 26 | Symmetric | Alumina | 87.53 | 0.0084 | 3240 | 31 | 1500 | 12 | 270 | 1.5 |
| Comp. Ex. 16 | 27 | Symmetric | Alumina | 1 [symbol] 1.32 | −0.1702 | 3240 | 31 | 1500 | 12 | 270 | 1.5 |
| Comp. Ex. 17 | 28 | Symmetric | Alumina | 151.32 | −0.1702 | 3240 | 31 | 1500 | 12 | 270 | 1.5 |
| Ex. 12 | 29 | Symmetric | Alumina | 151.32 | −0.1702 | 3240 | 31 | 1500 | 12 | 270 | 1.5 |
| Ex. 13 | 30 | Symmetric | Alumina | 38.8 | 0.0756 | 3240 | 38 | 3000 | 12 | 270 | 1.5 |
| Ex. 14 | 31 | Symmetric | Alumina | 38.8 | 0.0756 | 3240 | 38 | 3000 | 12 | 270 | 1.5 |
| Ex. 15 | 32 | Symmetric | Alumina | 38.8 | 0.0756 | 3240 | 38 | [symbol] 000 | 12 | 270 | 1.5 |
| Comp. Ex. 18 | 33 | Asymmetric | Aluminosilicate | 60.41 | 261.2599 | 1440 | 55 | 0.55 | 16 | 90 | 2 |
| Comp. Ex. 19 | 34 | Asymmetric | Aluminosilicate | 60.41 | 261.2599 | 1440 | 55 | 0.55 | 16 | 90 | 2 |
| Comp. Ex. 20 | 35 | Asymmetric | Aluminosilicate | 60.41 | 261.2599 | 1440 | 55 | 0.55 | 16 | 90 | 2 |
| Ex. 16 | 36 | Symmetric | Alumina | 43.28 | 0.0042 | 15000 | 30 | 50000 | 50 | 300 | 12.5 |
| Ex. 17 | 37 | Symmetric | Alumina | 43.28 | 0.0042 | 15000 | 30 | 50000 | 50 | 300 | 12.5 |
| Ex. 18 | 38 | Symmetric | Alumina | 43.28 | 0.0042 | 15000 | 30 | 50000 | 50 | 300 | 12.5 |
| Ex. 19 | 39 | Symmetric | Alumina | 42.85 | 0.0021 | 15000 | 30 | 100000 | 50 | 300 | 12.5 |
| Ex. 20 | 40 | Symmetric | Alumina | 42.85 | 0.0021 | 15000 | 30 | 100000 | 50 | 300 | 12.5 |
| Ex. 21 | 41 | Symmetric | Alumina | 42.85 | 0.0021 | 15000 | 30 | 100000 | 50 | 300 | 12.5 |
| Comp. Ex. 21 | 42 | Symmetric | Alumina | 50.01 | 0.3117 | 180 | 30 | 600 | 6 | 30 | 1 |
| Comp. Ex. 22 | 43 | Symmetric | Alumina | 50.01 | 0.3117 | 180 | 30 | 600 | 6 | 30 | 1 |
| Comp. Ex. 23 | 44 | Symmetric | Alumina | 50.01 | 0.3117 | 180 | 30 | 600 | 6 | 30 | 1 |
| Ex. 22 | 45 | Symmetric | Alumina | 38.8 | 0.0756 | 360 | 38 | 3000 | 12 | 30 | 1.5 |
| Ex. 23 | 46 | Symmetric | Alumina | 38.8 | 0.0756 | 360 | 38 | 3000 | 12 | 30 | 1.5 |
| Ex. 24 | 47 | Symmetric | Alumina | 38.8 | 0.0756 | 360 | 38 | 3000 | 12 | 30 | 1.5 |
| Comp. Ex. 24 | 48 | Symmetric | Alumina | 50.01 | 0.3117 | 1380 | 30 | 800 | 6 | 230 | 1 |
| Comp. Ex. 25 | 49 | Symmetric | Alumina | 50.01 | 0.3117 | 1380 | 30 | 800 | 6 | 230 | 1 |
| Ex. 25 | 50 | Symmetric | Alumina | 43.94 | 0.0004 | 15000 | 40 | 500000 | 50 | 300 | 12.5 |
| Ex. 26 | 51 | Symmetric | Alumina | 43.94 | 0.0004 | 15000 | 40 | 500000 | 50 | 300 | 12.5 |
| Ex. 27 | 52 | Symmetric | Alumina | 43.94 | 0.0004 | 15000 | 40 | 500000 | 50 | 300 | 12.5 |
| Comp. Ex. 26 | 53 | Symmetric | Metal | 64 | 0.0003 | 1385.4423 [symbol] | 47.7 | 500000 | 42 | Flat plate | 1.3 |
| Ex. 28 | 54 | Symmetric | Metal | 64 | 0.0003 | 1385.4423 [symbol] | 47.7 | 500000 | 42 | Flat plate | 1.3 |
| Ex. 29 | 55 | Symmetric | Metal | 64 | 0.0003 | 1385.4423 [symbol] | 47.7 | 500000 | 42 | Flat plate | 1.3 |
| Comp. Ex. 27 | 56 | Symmetric | Resin | 72 | 0.0225 | 900 | 40 | 4000 | 15 | 60 | 3 |
| Ex. 30 | 57 | Symmetric | Resin | 72 | 0.0225 | 900 | 40 | 4000 | 15 | 60 | 3 |
| Ex. 31 | 58 | Symmetric | Resin | 72 | 0.0225 | 900 | 40 | 4000 | 15 | 60 | 3 |
| Ex. 32 | 59 | Symmetric | Resin | 72 | 0.0225 | 900 | 40 | 4000 | 15 | 60 | 3 |

[symbol]

indicates data missing or illegible when filed

TABLE 2

| | | Flow speed test data | | | | | | | | | |
|---|---|---|---|---|---|---|---|---|---|---|---|
| | | | | | Time until | | | | | | |
| | | | Solvent | Applied | entire solvent | | | | Results | | |
| | | Solvent | amount | pressure | passes through | Flow rate Q | Pore area A | Flow speed V | Nanosight (NS-300) | | |
| Condition | No. | type | [mL] | [MPaG] | [sec.] | [m²/s] | [m²] | [m/s] | A^{Note} | B^{Note} | C^{Note} |
| Ex. 1 | 1 | Pure water | 200 | 0.1 | 14.37 | 0.00001392 | 1.00440E−03 | 0.013857 | 98.5 | 1.46E+08 | 7.3 |
| Ex. 2 | 2 | Pure water | 200 | 0.5 | 4.94 | 0.00004049 | 1.00440E−03 | 0.040308 | 91.2 | 2.33E+08 | 11.6 |
| Ex. 3 | 3 | Pure water | 200 | 0.9 | 3.01 | 0.00006 [symbol] 45 | 1.00440E−03 | 0.066154 | 10 [symbol] . [symbol] | 3.71E+08 | 18.5 |
| Comp. Ex. 1 | 4 | Pure water | 200 | 0.1 | 393.09 | 0.00000051 | 1.3 [symbol] 080E−03 | 0.000374 | 111.7 | 1.56E+07 | 0.8 |
| Comp. Ex. 2 | 5 | Pure water | 200 | 0.5 | 148.98 | 0.00000135 | 1.3 [symbol] 080E−03 | 0.000988 | 90.0 | 2.26E+07 | 1.1 |
| Ex. 4 | 6 | Pure water | 200 | 0.1 | 4.9 [symbol] | 0.00004016 | 1.44000E−03 | 0.027889 | 107.7 | 1.99E+08 | 10.0 |
| Ex. 5 | 7 | Pure water | 200 | 0.5 | 3. [symbol] 8 | 0.00005025 | 1.44000E−03 | 0.034897 | 91.8 | 3.03E+08 | 15.2 |
| Ex. 6 | 8 | Pure water | 200 | 0.9 | 2.501 | 0.00007 [symbol] 7 | 1.44000E−03 | 0.055533 | 122.4 | 2.88E+08 | 14.4 |
| Ex. 7 | 9 | Pure water | 200 | 0.1 | 3.66 | 0.00005464 | 1.44000E−03 | 0.037948 | 99. [symbol] | 2.78E+08 | 13.9 |
| Ex. 8 | 10 | Pure water | 200 | 0.5 | 2.549 | 0.00007846 | 1.44000E−03 | 0.064488 | 106.0 | 3.96E+08 | 19.8 |
| Ex. 9 | 11 | Pure water | 200 | 0.9 | 2.321 | 0.00006617 | 1.44000E−03 | 0.069840 | 94. [symbol] | 4.12E+08 | 20.6 |
| Comp. Ex. 3 | 12 | Pure water | 200 | 0.1 | 700 | 0.00000029 | 1.3 [symbol] 080E−03 | 0.000210 | 100.3 | 1.08E+07 | 0.5 |
| Comp. Ex. 4 | 13 | Pure water | 200 | 0.5 | 300 | 0.00000067 | 1.3 [symbol] 080E−03 | 0.000490 | 99.6 | 2.58E+07 | 1.3 |
| Comp. Ex. 5 | 14 | Pure water | 200 | 0.9 | 120 | 0.000001 [symbol] 7 | 1.3 [symbol] 080E−03 | 0.001225 | 107. [symbol] | 4.80E+07 | 2.4 |
| Comp. Ex. 6 | 15 | Pure water | 200 | 0.1 | [symbol] 254 | 0.00000003 | 1.3 [symbol] 080E−03 | 0.000024 | 102.3 | 3.98E+06 | 0.2 |
| Comp. Ex. 7 | 16 | Pure water | 200 | 0.5 | 1754 | 0.00000011 | 1.3 [symbol] 080E−03 | 0.000084 | 98.8 | 8.78E+06 | 0.4 |
| Comp. Ex. 8 | 17 | Pure water | 200 | 0.9 | 803.54 | 0.0000002 [symbol] | 1.3 [symbol] 080E−03 | 0.000183 | 99. [symbol] | 9.98E+06 | 0.5 |
| Comp. Ex. 9 | 18 | Pure water | 200 | 0.1 | 3 [symbol] 9 | 0.00000054 | 1.78200E−03 | 0.000304 | 82.4 | 2.42E+07 | 1.5 |
| Comp. Ex. 10 | 19 | Pure water | 200 | 0.5 | 126.8 | 0.00000158 | 1.78200E−03 | 0.000885 | 108.0 | 4.60E+07 | 2.3 |
| Comp. Ex. 11 | 20 | Pure water | 200 | 0.9 | 28.87 | 0.0000 [symbol] 3 | 1.78200E−03 | 0.003888 | 9 [symbol] .1 | 6.30E+07 | 3.2 |
| Comp. Ex. 12 | 21 | Pure water | 200 | 0.1 | 219.5 | 0.00000091 | 1.78200E−03 | 0.000511 | 102.6 | 3.88E+07 | 1.9 |
| Comp. Ex. 13 | 22 | Pure water | 200 | 0.5 | 38.91 | 0.00000514 | 1.78200E−03 | 0.002884 | 7 [symbol] .1 | 4.88E+07 | 2.4 |
| Comp. Ex. 14 | 23 | Pure water | 200 | 0.9 | 13.34 | 0.00001499 | 1.78200E−03 | 0.008413 | 79.8 | 6.76E+07 | 2.9 |
| Comp. Ex. 15 | 24 | Pure water | 200 | 0.1 | 112.7 [symbol] 9 | 0.00000177 | 1.00440E−03 | 0.0017 [symbol] | 127.7 | 6.48E+07 | 2.7 |
| Ex. 10 | 25 | Pure water | 200 | 0.5 | 14.747 | 0.00001358 | 1.00440E−03 | 0.013503 | 95.3 | 8.18E+07 | 4.1 |
| Ex. 11 | 26 | Pure water | 200 | 0.9 | 10.057 | 0.00001989 | 1.00440E−03 | 0.019800 | 109.0 | 1.34E+08 | 6.7 |
| Comp. Ex. 16 | 27 | Pure water | 200 | 0.1 | 621.9 [symbol] | 0.00000032 | 1.00440E−03 | 0.000320 | 91.5 | 4.28E+07 | 2.1 |
| Comp. Ex. 17 | 28 | Pure water | 200 | 0.5 | 40.19 | 0.00000498 | 1.00440E−03 | 0.004 [symbol] 55 | 121.7 | 5.68E+07 | 2. [symbol] |
| Ex. 12 | 29 | Pure water | 200 | 0.9 | 17.81 | 0.00001123 | 1.00440E−03 | 0.011180 | 121.2 | 6.82E+07 | 3.4 |
| Ex. 13 | 30 | Pure water | 200 | 0.1 | 10.182 | 0.00001984 | 1.23120E−03 | 0.015 [symbol] 54 | 96.8 | 6.98E+07 | 3.5 |
| Ex. 14 | 31 | Pure water | 200 | 0.5 | 3.7 [symbol] | 0.00005333 | 1.23120E−03 | 0.043318 | 95.0 | 2.03E+08 | 10.2 |
| Ex. 15 | 32 | Pure water | 200 | 0.9 | 2.77 | 0.00007220 | 1.23120E−03 | 0.068644 | 88.8 | 3.45E+08 | 17.2 |
| Comp. Ex. 18 | 33 | Pure water | 200 | 0.1 | 29285 | 0.00000001 | 7.92000E−04 | 0.000009 | 89.6 | 2.38E+0 [symbol] | 0.1 |
| Comp. Ex. 19 | 34 | Pure water | 200 | 0.5 | 110 [symbol] 1 | 0.00000002 | 7.92000E−04 | 0.000023 | 98. [symbol] | 6.18E+0 [symbol] | 0.3 |
| Comp. Ex. 20 | 35 | Pure water | 200 | 0.9 | 5845 | 0.00000003 | 7.92000E−04 | 0.000043 | 102.3 | 8.58E+0 [symbol] | 0.4 |
| Ex. 16 | 36 | Pure water | 200 | 0.1 | 2.39 | 0.00008368 | 4.50000E−03 | 0.018596 | 102.2 | 2.4 [symbol] E+08 | 12.3 |
| Ex. 17 | 37 | Pure water | 200 | 0.5 | 1.88 | 0.00010638 | 4.50000E−03 | 0.023 [symbol] 41 | 100.6 | 2.87E+08 | 14.3 |
| Ex. 18 | 38 | Pure water | 200 | 0.9 | 1.51 | 0.00013245 | 4.50000E−03 | 0.02 [symbol] 433 | 90. [symbol] | 3.10E+08 | 15.5 |
| Ex. 19 | 39 | Pure water | 200 | 0.1 | 2.25 | 0.00008889 | 4.50000E−03 | 0.01 [symbol] 753 | 96.5 | 2.58E+08 | 12.9 |
| Ex. 20 | 40 | Pure water | 200 | 0.5 | 1.95 | 0.00010256 | 4.50000E−03 | 0.022792 | 9 [symbol] .0 | 2.68E+08 | 13.3 |
| Ex. 21 | 41 | Pure water | 200 | 0.9 | 1.25 | 0.0001 [symbol] 000 | 4.50000E−03 | 0.035556 | 94.5 | 2.86E+08 | 14.3 |
| Comp. Ex. 21 | 42 | Pure water | 200 | 0.1 | 2001.36 | 0.00000010 | 5.40000E−05 | 0.001851 | 102.6 | 2.38E+07 | 1.2 |
| Comp. Ex. 22 | 43 | Pure water | 200 | 0.5 | 995. [symbol] 5 | 0.00000020 | 5.40000E−05 | 0.003720 | 104.4 | 5.82E+07 | 2.9 |
| Comp. Ex. 23 | 44 | Pure water | 200 | 0.9 | 780.41 | 0.0000002 [symbol] | 5.40000E−05 | 0.00474 [symbol] | 101.4 | 5.10E+07 | 2.6 |
| Ex. 22 | 45 | Pure water | 200 | 0.1 | 82.47 | 0.00000243 | 1.3 [symbol] 800E−04 | 0.017728 | 119.8 | 1.53E+08 | 7. [symbol] |
| Ex. 23 | 46 | Pure water | 200 | 0.5 | 16.03 | 0.000001248 | 1.3 [symbol] 800E−04 | 0.0 [symbol] 1203 | 108.9 | 5.32E+08 | 26.6 |
| Ex. 24 | 47 | Pure water | 200 | 0.9 | 11.99 | 0.000001668 | 1.3 [symbol] 800E−04 | 0.121 [symbol] 34 | [symbol] 7.0 | 6.24E+08 | 31.2 |
| Comp. Ex. 24 | 48 | Pure water | 200 | 0.1 | 78 [symbol] | 0.000000025 | 4.14400E−04 | 0.000613 | [symbol] .7 | 4. [symbol] 6E+07 | 2.5 |
| Comp. Ex. 25 | 49 | Pure water | 200 | 0.5 | 301.47 | 0.0000000 [symbol] | 4.14400E−04 | 0.001 [symbol] 02 | 149.2 | 4.76E+07 | 2.4 |
| Ex. 25 | 50 | Pure water | 200 | 0.1 | 1.8 [symbol] | 0.000105 [symbol] 2 | 6.00000E−03 | 0.017 [symbol] 37 | 102.4 | 2.7 [symbol] E+08 | 13.8 |
| Ex. 26 | 51 | Pure water | 200 | 0.5 | 1.11 | 0.00018018 | 6.00000E−03 | 0.0 [symbol] 0030 | 101.5 | 3.12E+08 | 15.6 |
| Ex. 27 | 52 | Pure water | 200 | 0.9 | 0.99 | 0.00020202 | 6.00000E−03 | 0.033 [symbol] 70 | 98.5 | 3.42E+08 | 17.1 |
| Comp. Ex. 26 | 53 | Pure water | 200 | 0.1 | [symbol] 2 | 0.00000385 | 6.60440E−04 | 0.00 [symbol] 824 | 112.7 | 3.72E+07 | 1.9 |
| Ex. 28 | 54 | Pure water | 200 | 0.5 | 31 | 0.00000 [symbol] 45 | 6.60440E−04 | 0.00 [symbol] 7 [symbol] 9 | 102.5 | 7.30E+07 | 3.7 |
| Ex. 29 | 55 | Pure water | 200 | 0.9 | 22 | 0.00000909 | 6.60440E−04 | 0.0137 [symbol] 5 | 80.2 | 1. [symbol] 2E+08 | 8.1 |
| Comp. Ex. 27 | 56 | Pure water | 200 | 0.005 | 644 | 0.00000031 | 3. [symbol] 0000E−04 | 0.000863 | 99.9 | 2.20E+07 | 1.1 |
| Ex. 30 | 57 | Pure water | 200 | 0.1 | 14.87 | 0.0000134 [symbol] | 3. [symbol] 0000E−04 | 0.037361 | 102.2 | 5.50E+07 | 2.8 |
| Ex. 31 | 58 | Pure water | 200 | 0.5 | 5.89 | 0.00003515 | 3. [symbol] 0000E−04 | 0.097637 | 112.5 | 1.78E+08 | 8. [symbol] |
| Ex. 32 | 59 | Pure water | 200 | 0.9 | 3.88 | 0.00006155 | 3. [symbol] 0000E−04 | 0.143184 | 9 [symbol] .4 | 2.70E+08 | 13.5 |

^{Note}
A: Bubble diameter [nm]
B: Bubble concentration [bubbles/mL]
C: Bubble concentration [particles/frame] [symbol]
indicates data missing or illegible when filed

TABLE 3

| | | Element data | | | | | | | | | |
|---|---|---|---|---|---|---|---|---|---|---|---|
| | | | | | Bubble point | Effective | | | Element | | |
| | | | | Contact | pressure | area of | Surface | Pore | outer | Element | Film |
| | | Element | Element | angle | (pure water) | element | porosity | diameter | diameter | length | thickness |
| | No. | structure | material | [°] | [MPaG] | [mm²] | [%] | [nm] | [mm] | [mm] | [mm] |
| Ex. 1 | 1 | Symmetric | Alumina | 43.55 | 0.1406 | 3240 | 31 | 1500 | 12 | 270 | 1.5 |
| Ex. 2 | 2 | Symmetric | Alumina | 43.55 | 0.1406 | 3240 | 31 | 1500 | 12 | 270 | 1.5 |
| Ex. 3 | 3 | Symmetric | Alumina | 43.55 | 0.1406 | 3240 | 31 | 1500 | 12 | 270 | 1.5 |
| Ex. 4 | 6 | Symmetric | Alumina | 43.81 | 0.0210 | 6000 | 24 | 10000 | 20 | 300 | 4 |
| Ex. 5 | 7 | Symmetric | Alumina | 43.81 | 0.0210 | 6000 | 24 | 10000 | 20 | 300 | 4 |
| Ex. 6 | 8 | Symmetric | Alumina | 43.81 | 0.0210 | 6000 | 24 | 10000 | 20 | 300 | 4 |
| Ex. 7 | 9 | Symmetric | Alumina | 49.23 | 0.0127 | 6000 | 24 | 15000 | 20 | 300 | 4 |
| Ex. 8 | 10 | Symmetric | Alumina | 49.23 | 0.0127 | 6000 | 24 | 15000 | 20 | 300 | 4 |
| Ex. 9 | 11 | Symmetric | Alumina | 49.23 | 0.0127 | 6000 | 24 | 15000 | 20 | 300 | 4 |
| Ex. 10 | 25 | Symmetric | Alumina | 87.53 | 0.0084 | 3240 | 31 | 1500 | 12 | 270 | 1.5 |
| Ex. 11 | 28 | Symmetric | Alumina | 87.53 | 0.0084 | 3240 | 31 | 1500 | 12 | 270 | 1.5 |
| Ex. 12 | 29 | Symmetric | Alumina | 151.32 | −0.1702 | 3240 | 31 | 1500 | 12 | 270 | 1.5 |
| Ex. 13 | 30 | Symmetric | Alumina | 38.8 | 0.075 [symbol] | 3240 | 38 | 3000 | 12 | 270 | 1.5 |
| Ex. 14 | 31 | Symmetric | Alumina | 38.8 | 0.075 [symbol] | 3240 | 38 | 3000 | 12 | 270 | 1.5 |
| Ex. 15 | 32 | Symmetric | Alumina | 38.8 | 0.075 [symbol] | 3240 | 38 | 3000 | 12 | 270 | 1.5 |
| Ex. 16 | 36 | Symmetric | Alumina | 43.28 | 0.0042 | 15000 | 30 | 50000 | 50 | 300 | 12.5 |
| Ex. 17 | 37 | Symmetric | Alumina | 43.28 | 0.0042 | 15000 | 30 | 50000 | 50 | 300 | 12.5 |
| Ex. 18 | 38 | Symmetric | Alumina | 43.28 | 0.0042 | 15000 | 30 | 50000 | 50 | 300 | 12.5 |
| Ex. 19 | 39 | Symmetric | Alumina | 42.85 | 0.0021 | 15000 | 30 | 100000 | 50 | 300 | 12.5 |
| Ex. 20 | 40 | Symmetric | Alumina | 42.85 | 0.0021 | 15000 | 30 | 100000 | 50 | 300 | 12.5 |
| Ex. 21 | 41 | Symmetric | Alumina | 42.85 | 0.0021 | 15000 | 30 | 100000 | 50 | 300 | 12.5 |
| Ex. 22 | 45 | Symmetric | Alumina | 38.8 | 0.0758 | 360 | 38 | 3000 | 12 | 30 | 1.5 |
| Ex. 23 | 46 | Symmetric | Alumina | 38.8 | 0.0758 | 360 | 38 | 3000 | 12 | 30 | 1.5 |
| Ex. 24 | 47 | Symmetric | Alumina | 38.8 | 0.0758 | 360 | 38 | 3000 | 12 | 30 | 1.5 |
| Ex. 25 | 50 | Symmetric | Alumina | 43.94 | 0.0004 | 1 [symbol] 000 | 40 | 500000 | 50 | 300 | 12.5 |
| Ex. 26 | 51 | Symmetric | Alumina | 43.94 | 0.0004 | 1 [symbol] 000 | 40 | 500000 | 50 | 300 | 12.5 |
| Ex. 27 | 52 | Symmetric | Alumina | 43.94 | 0.0004 | 1 [symbol] 000 | 40 | 500000 | 50 | 300 | 12.5 |
| Ex. 28 | 54 | Symmetric | Metal | 64 | 0.0003 | 1385.44236 | 47.7 | 500000 | 42 | Flat plate | 1.3 |
| Ex. 29 | 55 | Symmetric | Metal | 64 | 0.0003 | 1385.44236 | 47.7 | 500000 | 42 | Flat plate | 1.3 |
| Ex. 30 | 57 | Symmetric | Resin | 72 | 0.0225 | 900 | 40 | 4000 | 15 | 60 | 3 |
| Ex. 31 | 58 | Symmetric | Resin | 72 | 0.0225 | 900 | 40 | 4000 | 15 | 60 | 3 |
| Ex. 32 | 5 [symbol] | Symmetric | Resin | 72 | 0.0025 | 900 | 40 | 4000 | 15 | 60 | 3 |

[symbol]

indicates data missing or illegible when filed

TABLE 4

| | | Flow speed test data | | | | | | | | | |
|---|---|---|---|---|---|---|---|---|---|---|---|
| | | | | | Time until | | | | | | |
| | | | Solvent | Applied | entire solvent | | | | Results | | |
| | | Solvent | amount | pressure | passes through | Flow rate Q | Pore Area A | Flow speed V | Nanosight (NS-300) | | |
| Condition | No. | type | [mL] | [MPaG] | [sec.] | [m²/s] | [m²] | [m/s] | A^{Note} | B^{Note} | C^{Note} |
| Ex. 1 | 1 | Pure water | 200 | 0.1 | 14.37 | 0.00001392 | 1.00440E−03 | 0.013857 | 98.5 | 1.46E+08 | 7.3 |
| Ex. 2 | 2 | Pure water | 200 | 0.5 | 4.94 | 0.00004049 | 1.00440E−03 | 0.040308 | 91.2 | 2.33E+08 | 11.3 |
| Ex. 3 | 3 | Pure water | 200 | 0.9 | 3.01 | 0.0000 [symbol] 45 | 1.00440E−03 | 0.066154 | 10 [symbol] .0 | 3.71E+08 | 18.5 |
| Ex. 4 | 6 | Pure water | 200 | 0.1 | 4.98 | 0.00004016 | 1.44000E−03 | 0.027889 | 107.7 | 1.99E+08 | 10.0 |
| Ex. 5 | 7 | Pure water | 200 | 0.5 | 3.98 | 0.00005025 | 1.44000E−03 | 0.034897 | 91.8 | 3.03E+08 | 15.2 |
| Ex. 6 | 8 | Pure water | 200 | 0.9 | 2.501 | 0.00007997 | 1.44000E−03 | 0.056633 | 122.4 | 2.88E+08 | 14.4 |
| Ex. 7 | 9 | Pure water | 200 | 0.1 | 3. [symbol] | 0.00005464 | 1.44000E−03 | 0.037948 | 99.5 | 2.78E+08 | 13.9 |
| Ex. 8 | 10 | Pure water | 200 | 0.5 | 2.54 [symbol] | 0.0000784 [symbol] | 1.44000E−03 | 0.054488 | 10 [symbol] .0 | 3.98E+08 | 19.8 |
| Ex. 9 | 11 | Pure water | 200 | 0.9 | 2.321 | 0.00008617 | 1.44000E−03 | 0.059840 | 94. [symbol] | 4.12E+08 | 20. [symbol] |
| Ex. 10 | 25 | Pure water | 200 | 0.5 | 14.747 | 0.00001356 | 1.00440E−03 | 0.013503 | 9 [symbol] .3 | 8.18E+07 | 4.1 |
| Ex. 11 | 26 | Pure water | 200 | 0.9 | 10.067 | 0.00001989 | 1.00440E−03 | 0.019800 | 109.0 | 1.34E+08 | 6.7 |
| Ex. 12 | 29 | Pure water | 200 | 0.9 | 17.81 | 0.00001123 | 1.00440E−03 | 0.011180 | 121.2 | [symbol] . [symbol] 2E+07 | 3.4 |
| Ex. 13 | 30 | Pure water | 200 | 0.1 | 10.182 | 0.00001954 | 1.23120E−03 | 0.015 [symbol] 54 | 96.8 | 5.98E+07 | 3.5 |
| Ex. 14 | 31 | Pure water | 200 | 0.5 | 3.7 [symbol] | 0.00005333 | 1.23120E−03 | 0.043318 | 95.0 | 2.03E+08 | 10.2 |
| Ex. 15 | 32 | Pure water | 200 | 0.9 | 2.77 | 0.00007220 | 1.23120E−03 | 0.058644 | 88.8 | 3.45E+08 | 17.2 |
| Ex. 16 | 36 | Pure water | 200 | 0.1 | 2.39 | 0.000083 [symbol] 8 | 4.50000E−03 | 0.018 [symbol] | 102.2 | 2.4 [symbol] E+08 | 12.3 |
| Ex. 17 | 37 | Pure water | 200 | 0.5 | 1.88 | 0.00010 [symbol] 3 [symbol] | 4.50000E−03 | 0.023 [symbol] 41 | 100.6 | 2.87E+08 | 14.3 |
| Ex. 18 | 38 | Pure water | 200 | 0.9 | 1. [symbol] 1 | 0.0001324 [symbol] | 4.50000E−03 | 0.02 [symbol] 433 | 90.0 | 3.10E+08 | 15.5 |
| Ex. 19 | 39 | Pure water | 200 | 0.1 | 2.2 [symbol] | 0.00008889 | 4.50000E−03 | 0.019753 | 9 [symbol] .5 | 2.6 [symbol] E+08 | 12.9 |
| Ex. 20 | 40 | Pure water | 200 | 0.5 | 1.95 | 0.0001025 [symbol] | 4.50000E−03 | 0.022792 | 98.0 | 2.8 [symbol] E+08 | 13.3 |
| Ex. 21 | 41 | Pure water | 200 | 0.9 | 1.2 [symbol] | 0.00016000 | 4.50000E−03 | 0.03555 [symbol] | 94.5 | 2.8 [symbol] E+08 | 14.3 |
| Ex. 22 | 45 | Pure water | 200 | 0.1 | [symbol] 2.47 | 0.00000243 | 1.36800E−04 | 0.017728 | 119.8 | 1. [symbol] 3E+08 | 7. [symbol] |
| Ex. 23 | 46 | Pure water | 200 | 0.5 | 1 [symbol] .03 | 0.0000124 [symbol] | 1.36800E−04 | 0.091203 | 10 [symbol] .9 | 5.32E+08 | 26. [symbol] |
| Ex. 24 | 47 | Pure water | 200 | 0.9 | 11.99 | 0.000016 [symbol] 8 | 1.36800E−04 | 0.121934 | 97.0 | 5.24E+08 | 31.2 |
| Ex. 25 | 50 | Pure water | 200 | 0.1 | 1.89 | 0.00010 [symbol] 82 | 6.00000E−03 | 0.017 [symbol] 37 | 102.4 | 2.76E+08 | 13.8 |
| Ex. 26 | 51 | Pure water | 200 | 0.5 | 1.11 | 0.00018018 | 6.00000E−03 | 0.030030 | 101.5 | 3.12E+08 | 15. [symbol] |
| Ex. 27 | 52 | Pure water | 200 | 0.9 | 0.99 | 0.00020202 | 6.00000E−03 | 0.033 [symbol] 70 | 9 [symbol] .5 | 3.42E+08 | 17.1 |
| Ex. 28 | 54 | Pure water | 200 | 0.5 | 31 | 0.00000645 | 6.60440E−04 | 0.0097 [symbol] | 102.5 | 7. [symbol] 0E+07 | 3.7 |
| Ex. 29 | 55 | Pure water | 200 | 0.9 | 22 | 0.0000090 [symbol] | 6.60440E−04 | 0.013765 | 80.2 | 1. [symbol] 2E+08 | 8.1 |
| Ex. 30 | 57 | Pure water | 200 | 0.1 | 14.87 | 0.00001345 | 3.60000E−04 | 0.037381 | 102.2 | [symbol] . [symbol] 0E+07 | 2.8 |
| Ex. 31 | 58 | Pure water | 200 | 0.5 | 5. [symbol] 9 | 0.00003516 | 3.60000E−04 | 0.097637 | 112. [symbol] | 1.78E+08 | 8.9 |
| Ex. 32 | 59 | Pure water | 200 | 0.9 | 3.88 | 0.00005155 | 3.60000E−04 | 0.143184 | 98.4 | 2.70E+08 | 1 [symbol] .5 |

| | | | |
|---|---|---|---|
| Ave. | — | 100.80 | — |

^{Note}
A: Bubble diameter [nm]
B: Bubble concentration [bubbles/mL]
C: Bubble concentration [particles/frame] [symbol]
indicates data missing or illegible when filed

TABLE 5

| | | Element data | | | | | | | | | |
|---|---|---|---|---|---|---|---|---|---|---|---|
| | | | | | Bubble point | Effective | | | Element | | |
| | | | | Contact | pressure | area of | Surface | Pore | outer | Element | Film |
| | | Element | Element | angle | (pure water) | element | porosity | diameter | diameter | length | thickness |
| | No. | structure | material | [°] | [MPaG] | [mm²] | [%] | [nm] | [mm] | [mm] | [mm] |
| Comp. Ex. 1 | 4 | Asymmetric | Alumina | 31.4 | 3.1048 | 3240 | 42 | 80 | 12 | 270 | 1.5 |
| Comp. Ex. 2 | 5 | Asymmetric | Alumina | 31.4 | 3.1048 | 3240 | 42 | 80 | 12 | 270 | 1.5 |
| Comp. Ex. 3 | 12 | Asymmetric | Alumina | 109.08 | −1.1891 | 3240 | 42 | 80 | 12 | 270 | 1.5 |
| Comp. Ex. 4 | 13 | Asymmetric | Alumina | 109.08 | −1.1891 | 3240 | 42 | 80 | 12 | 270 | 1.5 |
| Comp. Ex. 5 | 14 | Asymmetric | Alumina | 123.6 | −1.1891 | 3240 | 42 | 80 | 12 | 270 | 1.5 |
| Comp. Ex. 6 | 15 | Asymmetric | Alumina | 123.6 | −2.0130 | 3240 | 42 | 80 | 12 | 270 | 1.5 |
| Comp. Ex. 7 | 16 | Asymmetric | Alumina | 123.6 | −2.0130 | 3240 | 42 | 80 | 12 | 270 | 1.5 |
| Comp. Ex. 8 | 17 | Asymmetric | Alumina | 123.6 | −2.0130 | 3240 | 42 | 80 | 12 | 270 | 1.5 |
| Comp. Ex. 9 | 18 | Asymmetric | Alumina | 37.05 | 1.1613 | 3240 | 42 | 200 | 12 | 270 | 1.5 |
| Comp. Ex. 10 | 19 | Asymmetric | Alumina | 37.05 | 1.1613 | 3240 | 55 | 200 | 12 | 270 | 1.5 |
| Comp. Ex. 11 | 20 | Asymmetric | Alumina | 37.05 | 1.1613 | 3240 | 55 | 200 | 12 | 270 | 1.5 |
| Comp. Ex. 12 | 21 | Asymmetric | Alumina | 40.15 | 0.5561 | 3240 | 55 | 400 | 12 | 270 | 1.5 |
| Comp. Ex. 13 | 22 | Asymmetric | Alumina | 40.15 | 0.5561 | 3240 | 55 | 400 | 12 | 270 | 1.5 |
| Comp. Ex. 14 | 23 | Asymmetric | Alumina | 40.15 | 0.5561 | 3240 | 55 | 400 | 12 | 270 | 1.5 |
| Comp. Ex. 15 | 24 | Symmetric | Alumina | 87.53 | 0.0084 | 3240 | 31 | 1500 | 12 | 270 | 1.5 |
| Comp. Ex. 16 | 27 | Symmetric | Alumina | 151.32 | −0.1702 | 3240 | 31 | 1500 | 12 | 270 | 1.5 |
| Comp. Ex. 17 | 28 | Symmetric | Alumina | 151.32 | −0.1702 | 3240 | 31 | 1500 | 12 | 270 | 1.5 |
| Comp. Ex. 18 | 33 | Asymmetric | Aluminosilicate | 60.41 | 2 [symbol] 1.2 [symbol] 99 | 1440 | 55 | 0.55 | 16 | 90 | 2 |
| Comp. Ex. 19 | 34 | Asymmetric | Aluminosilicate | 60.41 | 2 [symbol] 1.2 [symbol] 99 | 1440 | 55 | 0.55 | 16 | 90 | 2 |
| Comp. Ex. 20 | 35 | Asymmetric | Aluminosilicate | 60.41 | 2 [symbol] 1.2 [symbol] 99 | 1440 | 55 | 0.55 | 16 | 90 | 2 |
| Comp. Ex. 21 | 42 | Symmetric | Alumina | 50.01 | 0.3117 | 180 | 30 | 600 | 6 | 30 | 1 |
| Comp. Ex. 22 | 43 | Symmetric | Alumina | 50.01 | 0.3117 | 180 | 30 | 600 | 6 | 30 | 1 |
| Comp. Ex. 23 | 44 | Symmetric | Alumina | 50.01 | 0.3117 | 180 | 30 | 600 | 6 | 30 | 1 |
| Comp. Ex. 24 | 48 | Symmetric | Alumina | 50.01 | 0.3117 | 1380 | 30 | 600 | 6 | 230 | 1 |
| Comp. Ex. 25 | 49 | Symmetric | Alumina | 50.01 | 0.3117 | 1380 | 30 | 600 | 6 | 230 | 1 |
| Comp. Ex. 26 | 53 | Symmetric | Metal | 64 | 0.0003 | 1385.44236 | 47.7 | 500000 | 42 | Flat | 1.3 |
| | | | | | | | | | | plate | |
| Comp. Ex. 27 | 5 [symbol] | Symmetric | Resin | 72 | 0.0225 | 900 | 40 | 4000 | 15 | 60 | 3 |

[symbol]

indicates data missing or illegible when filed

TABLE 6

| | | Flow speed test data | | | | | | | | | |
|---|---|---|---|---|---|---|---|---|---|---|---|
| | | | | | Time until | | | | | | |
| | | | Solvent | Applied | entire solvent | | | | Results | | |
| | | Solvent | amount | pressure | passes through | Flow rate Q | Pore area A | Flow speed V | Nanosight (NS-300) | | |
| Condition | No. | type | [mL] | [MPaG] | [sec.] | [m²/s] | [m²] | [m/s] | A^{Note} | B^{Note} | C^{Note} |
| Comp. Ex. 1 | 4 | Pure water | 200 | 0.1 | 393.09 | 0.0000051 | 1.3 [symbol] 080E−03 | 0.000374 | 111.7 | 1.5 [symbol] E+07 | 0.8 |
| Comp. Ex. 2 | 5 | Pure water | 200 | 0.5 | 148. [symbol] | 0.000001 [symbol] | 1.3 [symbol] 080E−03 | 0.000988 | 90.0 | 2.26E+07 | 1.1 |
| Comp. Ex. 3 | 12 | Pure water | 200 | 0.1 | 700 | 0.00000029 | 1.3 [symbol] 080E−03 | 0.000210 | 100.3 | 1.0 [symbol] E+07 | 0.5 |
| Comp. Ex. 4 | 13 | Pure water | 200 | 0.5 | 300 | 0.00000067 | 1.3 [symbol] 080E−03 | 0.000490 | 99.5 | 2. [symbol] 8E+07 | 1.3 |
| Comp. Ex. 5 | 14 | Pure water | 200 | 0.9 | 120 | 0.00000167 | 1.3 [symbol] 0E−03 | 0.001225 | 107.6 | 4.80E+07 | 2.4 |
| Comp. Ex. 6 | 15 | Pure water | 200 | 0.1 | 6254 | 0.00000003 | 1. [symbol] 080E−03 | 0.000024 | 102.3 | 3.9 [symbol] E+0 [symbol] | 0.2 |
| Comp. Ex. 7 | 16 | Pure water | 200 | 0.5 | 1754 | 0.00000011 | 1.3 [symbol] 080E−03 | 0.000084 | 98.5 | 8.78E+06 | 0.4 |
| Comp. Ex. 8 | 17 | Pure water | 200 | 0.9 | 803.54 | 0.00000025 | 1.3 [symbol] 080E−03 | 0.000183 | 99.8 | 9.99E+08 | 0. [symbol] |
| Comp. Ex. 9 | 18 | Pure water | 200 | 0.1 | 3 [symbol] | 0.00000054 | 1.78200E−03 | 0.000304 | 82.4 | 2.42E+07 | 1.2 |
| Comp. Ex. 10 | 19 | Pure water | 200 | 0.5 | 12 [symbol] .8 | 0.00000168 | 1.78200E−03 | 0.000885 | 108.0 | 2.80E+07 | 2.3 |
| Comp. Ex. 11 | 20 | Pure water | 200 | 0.9 | 28.87 | 0.00000 [symbol] 3 | 1.78200E−03 | 0.003888 | 69.1 | 6.30E+07 | 3.2 |
| Comp. Ex. 12 | 21 | Pure water | 200 | 0.1 | 21 [symbol] .5 | 0.000000 [symbol] 1 | 1.78200E−03 | 0.000511 | 102.6 | 3.88E+07 | 1.9 |
| Comp. Ex. 13 | 22 | Pure water | 200 | 0.5 | 38.91 | 0.00000514 | 1.78200E−03 | 0.002884 | 75.1 | 4.88E+07 | 2.4 |
| Comp. Ex. 14 | 23 | Pure water | 200 | 0.9 | 13.3 [symbol] | 0.00001499 | 1.78200E−03 | 0.008413 | 7 [symbol] . [symbol] | 5.76E+07 | 2.9 |
| Comp. Ex. 15 | 24 | Pure water | 200 | 0.1 | 112. [symbol] | 0.00000177 | 1.00440E−03 | 0.001766 | 127.7 | 5.4 [symbol] E+07 | 2.7 |
| Comp. Ex. 16 | 27 | Pure water | 200 | 0.1 | [symbol] 21.96 | 0.00000032 | 1.00440E−03 | 0.000320 | 91.5 | 4.2 [symbol] E+07 | 2.1 |
| Comp. Ex. 17 | 28 | Pure water | 200 | 0. [symbol] | 40.19 | 0.00000 [symbol] 98 | 1.00440E−03 | 0.004955 | 121.7 | 5. [symbol] E+07 | 2. [symbol] |
| Comp. Ex. 18 | 33 | Pure water | 200 | 0.1 | 29265 | 0.00000001 | 7.92000E−04 | 0.000009 | 89.8 | 2.38E+08 | 0.1 |
| Comp. Ex. 19 | 34 | Pure water | 200 | 0. [symbol] | 110 [symbol] 1 | 0.00000002 | 7.92000E−04 | 0.000023 | 98.8 | 6.18E+0 [symbol] | 0.3 |
| Comp. Ex. 20 | 35 | Pure water | 200 | 0.9 | 5845 | 0.00000003 | 7.92000E−04 | 0.000043 | 102.3 | 8.53E+0 [symbol] | 0.4 |
| Comp. Ex. 21 | 42 | Pure water | 200 | 0.1 | 2001.35 | 0.00000010 | 5.40000E−05 | 0.001851 | 102.6 | 2.38E+07 | 1.2 |
| Comp. Ex. 22 | 43 | Pure water | 200 | 0. [symbol] | [symbol] . [symbol] 5 | 0.00000020 | 5.40000E−05 | 0.003720 | 104.4 | 5.82E+07 | 2.9 |
| Comp. Ex. 23 | 44 | Pure water | 200 | 0.9 | 780.41 | 0.0000002 [symbol] | 5.40000E−05 | 0.004746 | 101.4 | 5.10E+07 | 2.6 |
| Comp. Ex. 24 | 46 | Pure water | 200 | 0.1 | 788 | 0.0000002 [symbol] | 4.14000E−04 | 0.000813 | 95.7 | 4.96E+07 | 2.5 |
| Comp. Ex. 25 | 49 | Pure water | 200 | 0.5 | 301.47 | 0.000000 [symbol] | 4.14000E−04 | 0.001602 | 149.2 | 4.75E+07 | 2.4 |
| Comp. Ex. 26 | 53 | Pure water | 200 | 0.1 | 52 | 0.00000385 | 6.60440E−04 | 0.005824 | 112.7 | 3.72E+07 | 1.9 |
| Comp. Ex. 27 | 5 [symbol] | Pure water | 200 | 0.00 [symbol] | [symbol] 44 | 0.00000031 | 3.60000E−04 | 0.000863 | 99.9 | 2.20E+07 | 1.1 |

^{Note}
A: Bubble diameter [nm]
B: Bubble concentration [bubbles/mL]
C: Bubble concentration [particles/frame] [symbol]
indicates data missing or illegible when filed

TABLE 7

| | | | Pore | |
|---|---|---|---|---|
| Condition | No. | Flow speed V | concentration | Judgement |
| Comp. Ex. 23 | 44 | 0.004746 | 5.10E+07 | Unacceptable |
| Comp. Ex. 17 | 28 | 0.004955 | 5.68E+07 | Unacceptable |
| Comp. Ex. 14 | 23 | 0.008413 | 5.76E+07 | Unacceptable |
| Ex. 28 | 54 | 0.009769 | 7.30E+07 | Acceptable |
| Ex. 12 | 29 | 0.011180 | 6.82E+07 | Acceptable |
| Ex. 10 | 25 | 0.013503 | 8.18E+07 | Acceptable |

### (1) Element Structure

For the element structure, the term “symmetric structure” means that the element has a single structure. The term “asymmetric structure” means that inner and outer portions of the element have different structures. More specifically, the asymmetric structure is a two-layer structure in which the outer portion (i.e., outer layer) of the element is smaller in average pore diameter than the inner portion (i.e., inner layer) of the element.

### (2) Element Material

The element material is the material forming the element. Therefore, the element is a porous member formed of this material.

### (3) Contact Angle

As is well known, the contact angle is the angle between the free surface of a stationary liquid and a wall at a point where the free surface of the liquid contacts the wall.

In Experimental Example 1, a DropMaster series (DMo-501) was used to measure the contact angle by a droplet method. The liquid used was pure water (4 μL), and the contact angle 100 ms after the liquid was dropped was obtained.

The maximum pore diameter DBP [m] of the pores, the surface tension γ [N/m] of the liquid, the contact angel 0 [rad], and the bubble point pressure P [Pa] satisfy the relation represented by formula (1) below. The maximum pore diameter DBP [m] of a pore is the diameter of the pore when the pore is assumed to be a circular pore.

DBP=4γ cos θ/P (1)

### (4) Bubble Point Pressure

For example, a plate-shaped element is immersed in a liquid such as isopropyl alcohol and is held horizontally. Then air is supplied from the lower side of the element, and the pressure of the air is increased. When the pressure reaches a certain value, an air bubble is first generated from a pore with a maximum pore diameter. The pressure at this point is referred to as the bubble point pressure. The maximum pore diameter can be determined from the bubble point pressure using formula (1) above.

### (5) Pure Water

In Experimental Example 1, the liquid used was pure water. The pure water is generally a liquid subjected to demineralization/deionization treatment using, for example, an ion-exchange resin and has an electric conductivity in a prescribed range and a TOC (total organic carbon) in a prescribed range.

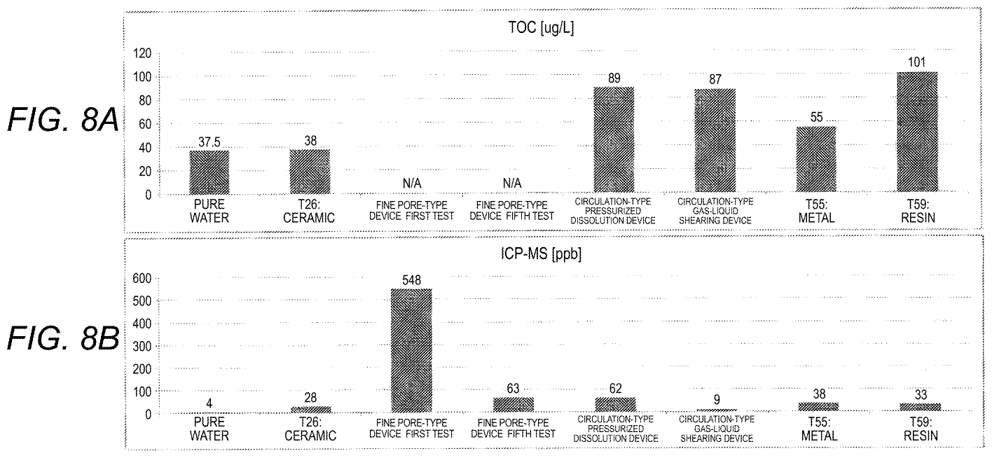

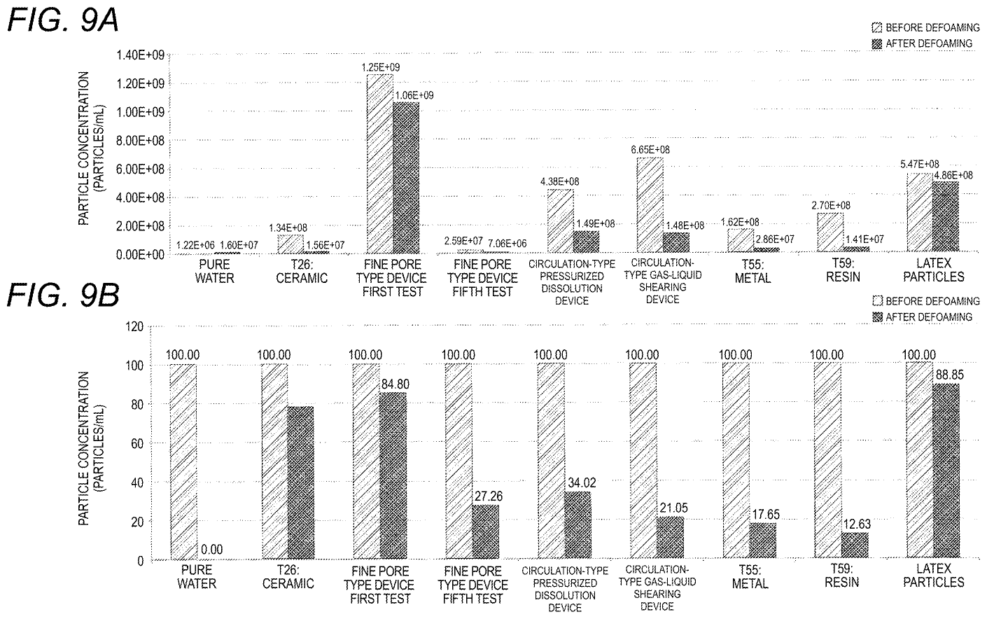

In Experimental Example 1, as shown in FIG. 8 below, the conductivity (i.e., the electric conductivity) [μS/m]. TOC (total organic carbon) [μg/L], ICP-MS (ion concentration), pH, DO (dissolved oxygen) [mg/L], and ATP (viable count) [RLU] were examined for 5 different types of pure water (5 samples: N1 to N5) used in the experiment.

The pH and the electric conductivity were measured using a pH/water quality meter D-74 manufactured by HORIBA.

The TOC was measured using TOC-VWP manufactured by Shimadzu Corporation. The ICP-MS was measured using SCIENTIFIC iCAP Q manufactured by Thermo Fisher. The DO was measured using OM-71 manufactured by HORIBA Ltd. The ATP was measured using Lumitester PD-30.

A NanoSight NS-300 (hereinafter referred to simply as NanoSight) was used to examine the bubble diameter [nm], the bubble concentration [bubbles/mL], and the bubble concentration [particles/frame]. The term [particles/frame] represent the number of particles in one image obtained through the measurement using the NanoSight, and 1500 frames are captured in one measurement. Specifically, the average of the numbers of particles in 1500 frames is represented by [particles/frame].

The results are shown in Table 8 below.

The pure water used in the experiment has an electric conductivity within the range of 47.9 to 83.2 [μS/m] and a TOC value within the range of 5 to 40.1 [μg/L]. Water whose electric conductivity and TOC value fall within these ranges can be regarded as pure water.

TABLE 8

| | | N1 | N2 | N3 | N4 | N5 | Ave | Max. | Min. | S.D. |
|---|---|---|---|---|---|---|---|---|---|---|
| Electric conductivity [uS/m] | | 58.6 | 47.9 | 83.2 | 59.6 | 66.7 | 63.2 | [symbol] 3.2 | 47.9 | 13.043 |
| TOC[μg/L] | | 28.4 | 5 | 40.1 | 22.5 | 37.5 | 26.7 | 40.1 | 5 | 14.032 |
| ICP-MS | | 7 | 4 | 8 | 6 | 7 | 6.4 | 8 | 4 | 1.517 |
| pH | | 5.83 | 6.02 | 5.99 | 6.21 | 6.08 | 6.026 | 6.21 | 5.83 | 0.138 |
| DO[mg/L] | | 7.34 | 8.01 | 8.21 | 7. [symbol] 5 | 7. [symbol] 4 | 7.83 | 8.21 | 7.34 | 0.342 |
| ATP[RLU] | | 1.3 | 0.7 | 2. [symbol] | 1.2 | 2.2 | 1.6 | 2. [symbol] | 0.7 | 0.778 |
| NanoSight | Bubble diameter | 98.6 | 96.4 | 100.2 | 102.9 | 103.2 | 100.2 [symbol] | 103.2 | 96.4 | 2.884 |
| (NS-300) | [nm] | | | | | | | | | |
| | Bubble concentration | 3.81E+05 | 1.61E+05 | 2.98E+06 | 7.81E+05 | 1.78E+06 | 1.22E+06 | 2.98E+06 | 1.61E+05 | 1.17E+06 |
| | [bubbles/mL] | | | | | | | | | |
| | Bubble concentration | 0.0 | 0.0 | 0.2 | 0.0 | 0.1 | 0.0618 | 0.15 | 0.009 | 0.058 |
| | [particles/frame] | | | | | | | | | |

[symbol]

indicates data missing or illegible when filed

### (6) Effective Area of Element

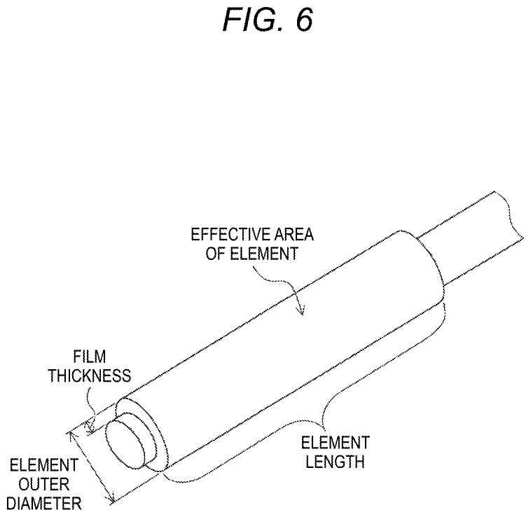

In Experimental Example 1, a cylindrical element shown in FIG. 6 was used. Therefore, the area of the side surface (i.e., the outer circumferential surface of the cylinder) of the element through which the liquid can pass is used as the effective area of the element.

The element length is the length of the element in its axial direction, and the element outer diameter is the diameter of the outer circumference of the element as it is viewed in the axial direction. Therefore, the effective area of the element can be determined from the element length and the element outer diameter. The film thickness is the thickness (radial dimension) of the cylindrical element.

### (7) Surface Porosity

The surface porosity is the surface ratio of the pores to the effective area of the element. The surface porosity can be determined by obtaining an image of the surface of the element using, for example, a scanning electron microscope (SEM), binarizing the image (into a black-and-white image), and determining the ratio of the area of the black portions (specifically, the ratio of the black portions indicating pores to the effective area of the element).

### (8) Pore Diameter (i.e., Average Pore Diameter)

The pore diameter is the diameter of a pore when the pore is assumed to be a circular pore (specifically, the average of the diameters of a large number of pores: the average pore diameter). In this case, the pore diameter was measured using mercury porosimetry. In the mercury porosimetry, AutoPore IV 9510 (manufactured by Shimadzu Corporation) was used.

### (9) Solvent Type

The solvent type means a liquid in which fine bubbles are generated and is pure water in the experiment.

### (10) Solvent Amount

The solvent amount means the amount (VO [mL]) of the liquid supplied to the first tank.

### (11) Applied Pressure

The applied pressure is the pressure of the gas supplied from the gas cylinder to the first tank (i.e., the pressure inside the first tank).

### (12) Time Until Entire Solvent Passes Through

The time until the entire solvent passes through is the time [sec.] until the entire liquid in the first tank (i.e., the liquid in the inner space of the element) moves to the second tank (i.e., the outer space of the element).

### (13) Flow Rate Q

The flow rate Q [m³/s] is the amount [m³] of the liquid moved from the inner side of the element to the outer side per unit time [sec]. The flow rate Q can be determined by dividing the “solvent amount” by the “time until entire solvent passes through.”

### (14) Pore Area A

The pore area A [m²] is the total pore area on the outer surface of the element. Specifically, the pore area A is the total area of the pores in the effective area of the element. The total pore area can be determined by obtaining an image of the surface of the element using, for example, an SEM, binarizing the image (into a black-and-white image), and determining the total area of the black portions representing the pores.

### (15) Flow Speed V

The flow speed V [m/s] is the flow speed of the liquid during passage through the pores of the element and can be determined by dividing the flow rate Q [m³/s] by the pore area A [m²].

### (16) Bubble Diameter and Bubble Concentration

The bubble diameter and the bubble concentration were measured by the NanoSight.

### <Evaluation>

In each of the samples of the Examples, the flow rate is 0.009769 [m/s] or more, and these samples realize high bubble concentrations and are preferable. For example, even sample No. 54 whose liquid flow speed is smallest realizes a bubble concentration of 7.30×10⁷ [bubbles/mL] and is preferable.

As is clear from Tables 1 to 4, in each of the samples of the Examples, the pore diameter (i.e., the average pore diameter) of the element is 1.5 μm to 500 μm. This shows that when the pore diameter falls within this range, a high bubble concentration can be obtained.

The lower limit (1.5 μm) of the average pore diameter is shown as the average pore diameters of samples Nos. 1 to 3 etc., and the upper limit (500 μm) of the average pore diameter is shown as the average pore diameters of samples Nos. 50, 51, 52, etc.

As is clear from Tables 1 to 4, in each of the samples of the Examples, the surface porosity of the element is 24% to 47.7%. This shows that when the surface porosity falls within this range, a high bubble concentration can be obtained as described above.

The lower limit (24%) of the surface porosity is shown as the surface porosities of samples Nos. 6 to 11, and the upper limit (47.7%) of the surface porosity is shown as the surface porosities of samples Nos. 54 and 55.

Moreover, as is clear from Tables 1 to 4, in each of the samples of the Examples, the contact angle of the liquid (pure water) on the surface of the element is 38.8° to 151.32°. When the contact angle is within this range, a high bubble concentration can be obtained as described above.

The lower limit (38.8°) of the contact angle is determined based on the contact angle in sample No. 30 etc., and the upper limit (151.32°) of the contact angle is determined based on the contact angle in sample No. 29.

### 5-2. Experimental Example 2

As described above, the conventional techniques in Japanese Patent Application Laid-Open (kokai) No. 2002-301345 and Japanese Patent Application Laid-Open (kokai) No. 2017-217585 differ totally from the present disclosure. Specifically, in these techniques, large air bubbles contained in water in the pre-stage tank are sheared to form fine air bubbles. These techniques require shearing of the bubbles.

In contrast, in the present disclosure, as shown in, for example, the first embodiment, the bubble diameter of the bubbles contained in the first tank is almost the same as the bubble diameter of the bubbles contained in the second tank. Namely, in the technique of the present disclosure, when, for example, the liquid in the first tank passes through the pores in the porous element, a rapid change in pressure occurs, and fine bubbles are thereby generated. The bubble diameter hardly changes due to passage through the element (i.e., the bubble diameter after passage through the element is almost the same as the bubble diameter before passage through the element). To cause the above phenomenon to occur, the flow speed must be 0.009769 [m/s] or more as described above.

In Experimental Example 2, in view of the above findings, a change in bubble diameter due to passage of the liquid (pure water) through the element (i.e., the difference between the bubble diameter before passage of the liquid through the element and the bubble diameter after passage of the liquid through the element) was examined.

In Experimental Example 1 described above, the NanoSight was used to examine the bubble diameters of the fine bubbles in the liquid in the first tank. Usually, fine bubbles are present in a liquid, although their amount is small.

In the samples of the Examples, the average bubble diameter of the fine bubbles in the liquid before passage through the element was 100.26 nm.

In the samples of the Examples, the average bubble diameter of the fine bubbles in the liquid after passage through the element was 100.80 nm (see the average value (Ave.) for the Examples in Table 4).

As can be seen from the above, the liquid that has passed through the element has an increased fine bubble concentration, but the average bubble diameter hardly changes due to passage of the element (i.e., the bubble diameter after passage through the element is almost the same as the bubble diameter before passage through the element).

### 5-3. Experimental Example 3

In Experimental Example 3, commercial nozzle-type fine bubble generation devices available from two companies were used to examine the state of fine bubbles generated.

In the nozzle type, a pump is used to cause a liquid (pure water) to flow through a tube having a wall surface including pores formed therein, and air is supplied to an intermediate portion of the tube from the outside through the pores.

In Experimental Example 3, the bubble concentration of fine bubbles generated was measured using the NanoSight under the conditions shown in Table 9 below. Specifically, the bubble concentration in the case of one pass (the liquid was not circulated) and the bubble concentration in the case where the liquid was circulated using a pump for 60 minutes were measured.

TABLE 9

| | | Solvent | Pump flow | | Generation |
|---|---|---|---|---|---|
| | Pump | amount | rate | Gas | time |
| Company A | MD- | 1 L | 33 L/min | Air (natural | 60 min. |
| | 70RZ | | | intake) | |
| Company B | MD- | 1 L | 33 L/min | Air (natural | 60 min. |
| | 70RZ | | | intake) | |

With these fine bubble generation devices from the two companies, only bubble concentrations lower than the reliable range of the NanoSight (i.e., 2×10⁸ [bubbles/mL] or more) could be measured. The experimental data is shown in Table 10 below.

TABLE 10

| | | After circulation for 60 |
|---|---|---|
| | One pass [bubbles/mL] | minutes [bubbles/mL] |
| Company A | 1.05E+04 | 5.12E+06 |
| Company B | 7.05E+04 | 1.08E+07 |

Notably, in a concentration range lower than the reliable range of the NanoSight, errors are large, and the reliability is not sufficient.

### 5-4. Experimental Example 4

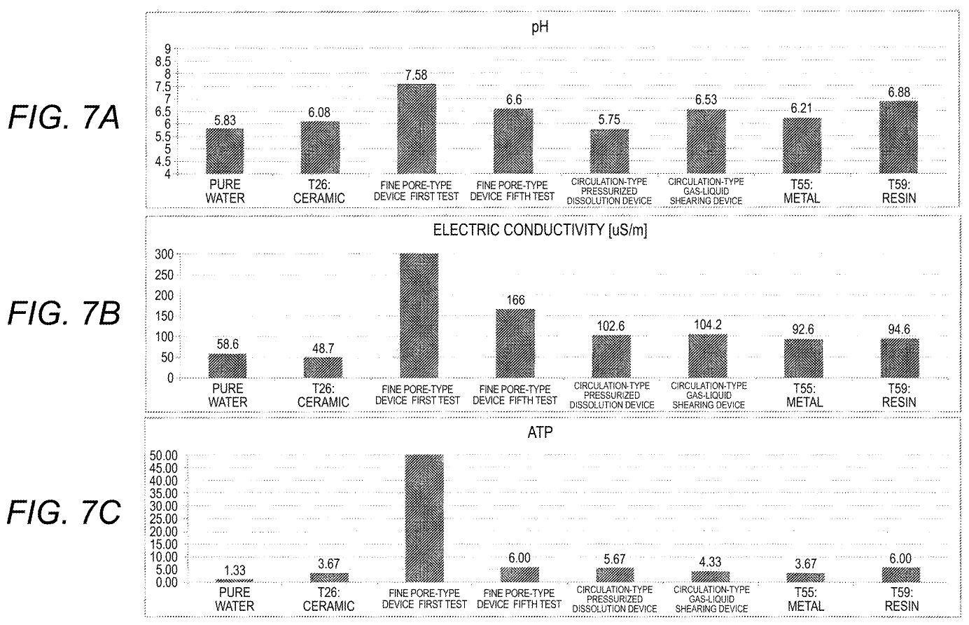

In Experimental Example 4, as shown in FIGS. 7 and 8, the liquid used was pure water, and fine bubbles were generated using the fine bubble generation devices of Examples used in Experimental Example 1 and various fine bubble generation devices other than those of the present disclosure. Various characteristics of the fine bubble liquids (specifically, different types of fine bubble water) were examined. When the characteristics were examined, glass-made containers of the same type were used as containers, in which the fine bubble liquids were placed, so that measurement environments were as close to each other as possible.

The details will next be described.

### <Samples, Devices, Etc.>

In FIGS. 7 and 8, “T26: ceramic” represents sample No. 26, which is an Example, and “T55: metal” represents sample No. 55 which is an Example. “T59: resin” represents sample No. 59 which is an Example.

The fine pore-type device is a fine pore-type fine bubble generation device using the ceramic-made element from the company C (i.e., a Comparative Example). In this fine bubble generation device, a porous element (i.e., a pipe) having a closed forward end is submerged in a liquid, and a gas is supplied to the pipe to generate fine bubbles on the outer side of the pipe.

The characteristics in the first test are the characteristics of the fine bubble liquid after fine bubbles are first generated under the following conditions, and the characteristics in the fifth test are the characteristics of the fine bubble liquid after fine bubbles are generated five times under the same conditions.

### (Experimental Conditions)

Setting pressure: 0.11 MPa

Treatment time: 1 hour

Solvent: pure water 500 mL

Gas type: nitrogen gas

Gas flow rate: 600 mL/min

A well-known circulation-type pressurized dissolution device and a well-known circulation-type gas-liquid shearing device were used as other Comparative Examples so as to generate fine bubbles, and the characteristics of the fine bubble liquids were examined.

### <Evaluation>

FIG. 7A shows the results of the examination of the pH value of each fine bubble liquid. As can be seen from FIG. 7A, the pH value of each of the fine bubble liquids produced by the samples of the Examples is close to the pH value of pure water. However, the fine bubble liquid produced in the first test with the fine pore-type has a large pH value of 7 or more.

FIG. 7B shows the results of the examination of the electric conductivity of each fine bubble liquid. As can be seen from FIG. 7B, the electric conductivity of each of the fine bubble liquids produced by the samples of the Examples is close to the electric conductivity of pure water. However, the fine bubble liquid produced in the first test with the fine pore-type has a very high electric conductivity of 738 [μS/m]. In the case of use of other generation types also, an increase in electric conductivity is found.

FIG. 7C shows the results of the examination of the ATP value of each fine bubble liquid. As can be seen from FIG. 7C, the ATP value of each of the fine bubble liquids produced by the samples of the Examples is close to the ATP value of pure water. However, the fine bubble liquid produced in the first test with the fine pore-type has a very high ATP value of 55.

FIG. 8A shows the results of the examination of the TOC value of each fine bubble liquid. As can be seen from FIG. 8A, the TOC value of each of the fine bubble liquids produced by the samples (T26 and T55) of Examples is close to the TOC value of pure water. The fine bubble liquids produced by the sample (T59) which is an Example, the circulation-type pressurized dissolution device, and the circulation-type gas-liquid shearing device, respectively, have large TOC values. In the case of use of the fine pore-type, the TOC value could not be measured.

FIG. 8B shows the results of the examination of the ICP-MS value of each fine bubble liquid. As can be seen from FIG. 8B, the ICP-MS value of each of the fine bubble liquids produced by the samples of the Examples is close to the ICP-MS value of pure water. However, the fine bubble liquid produced in the first test with the fine pore-type has a very high ICP-MS value of 548 [ppb].

### 5-5. Experimental Example 5

In Experimental Example 5, whether fine bubbles generated in a fine bubble generation device were actually fine bubbles or particles such as fine dust particles (i.e., solid particles) was examined. Specifically, since the NanoSight occasionally counts fine particles as fine bubbles, how close the actually measured particle concentration (i.e., the bubble concentration in the case of bubbles) was to the concentration of the fine bubbles was examined.

### <Samples, Devices, Etc.>

Liquids used for the particle concentration measurement are almost the same as those in Experimental Example 4. Specifically, pure water, the fine bubble liquid obtained by T26, the fine bubble liquid obtained by the fine pore-type device (in the first test), the fine bubble liquids obtained by the circulation-type pressurized dissolution device and the circulation-type gas-liquid shearing device, and the fine bubble liquids obtained by T55 and T59 were used. In addition, a liquid obtaining by dispersing Latex particles in a solvent (pure water) was also used.

### <Details of Experiment>

In Experimental Example 5, each of the liquids of the samples was first frozen and then melted, and the particle concentrations before and after freezing were examined using the NanoSight.

When a liquid containing air bubbles and solid particles is cooled and frozen, many bubbles disappear. Therefore, this freezing method enables determination of the amount of air bubbles actually present in the liquid before freezing through measurement of the particle concentration of the liquid before and after freezing.

Specifically, a method for distinguishing air bubbles and solid particles from each other using a slow freezing-thawing method disclosed in the 8th International Symposium on Fine Bubbles was used. More specifically, each of the samples was cooled and frozen at a prescribed cooling rate (e.g., 0.57×10⁻² [K/s]) and then heated and melted at a prescribed heating rate (e.g., 0.76×10⁻² [K/s]), and the particle concentration of the liquid was measured before and after freezing.

### <Evaluation>

FIG. A shows the particle concentrations before and after freezing of samples obtained in Experimental Example 5. In this graph, the particle concentrations of each sample are shown in a two-bar chart. The left bar represents the particle concentration before freezing, and the right bar represents the particle concentration after freezing. FIG. DB is a graph obtained by modifying the graph of FIG. A in such a manner that the particle concentration of each sample after freezing is determined with the particle concentration before freezing (i.e., before defoaming) set to 100. In FIGS. A and DB, the left bar in each pair of bars represents the particle concentration before defoaming, and the right bar represents the particle concentration after defoaming.

As is clear from FIGS. A and DB, in the case of the sample T26 which is an Example, the particle concentration after freezing is lowered largely. Specifically, as shown in Table 11 below, the defoaming ratio of the sample T26 which is an Example is 88.36%, and almost all the particles are air bubbles. The defoaming ratio is an index indicating the ratio of air bubbles to the detected particles and is defined as “(the particle concentration of the liquid after freezing)/(the particle concentration of the liquid before freezing)×100.”

TABLE 11
Deforming ratio [%]

| | Fine | Fine | circulation-type | Circulation-type | | | |
|---|---|---|---|---|---|---|---|
| | pore-type | pore-type | pressurized | gas-liquid | | | |
| T26 | device: | device: | dissolution | shearing | T55 | T59 | Latex |
| ceramic | first test | fifth test | device | device | metal | resin | resin |
| 88.36 | 15.20 | 72.74 | 65.98 | 78.95 | 82.35 | 87.37 | 11.15 |

As is clear from Table 11 etc., in the case of the sample T55 which is an Example, the defoaming ratio was 82.35%, which shows that almost all the particles were air bubbles. In the case of the sample T59 which is an Example, the defoaming ratio was 87.37%, which shows almost all the particles were air bubbles.

However, in the first test with the fine pore-type device which is one Comparative Example, the defoaming ratio was 15.20%, which shows that almost all the particles were solid particles. In the fifth test with the fine pore-type device, although the defoaming ratio was 72.74%, the particle concentration before defoaming was 2.59 E+07 [bubbles/mL] and was small (see FIG. A).

In the case of the circulation-type pressurized dissolution device which is another Comparative Example, the defoaming ratio was 65.98%, and the amount of solid particles was larger than that in the Examples.

Similarly, in the case of the circulation-type gas-liquid shearing device which is still another Comparative Example, the defoaming ratio was 78.95%, and the amount of solid particles was larger than that in the Examples.

In the sample containing the Latex particles added thereto, the defoaming ratio was 11.15%.

### 6. OTHER EMBODIMENTS

The present disclosure is not limited to the embodiments described above, etc., and it will be appreciated that the present disclosure can be implemented in various forms so long as they fall within the technical scope of the disclosure.

(1) For example, the element may have any of various shapes such as the shape of a tube with a closed end, the shape of a tube which is open at opposite ends in the axial direction, and the shape of a plate.

(2) The material used for the element may be any of various materials other than ceramics such as metals and resins.

(3) When an on-off valve is provided in a flow channel for supplying liquid or gas or a flow channel for withdrawing liquid, the operation of the on-off valve may be controlled by, for example, a computer.

For example, the amount of the liquid supplied to the first tank and the flow rate of the liquid may by measured by sensors, and the pressure inside the first tank may be measured by a sensor. Then the on-off operation of the on-off valve may be controlled according to the values measured by the sensors such that the flow rate, etc. of the liquid and the pressure inside the first tank become equal to respective target values. Therefore, the structures for generating fine bubbles can be arranged in-line.

(4) The function of one component in any of the above embodiments may be distributed to a plurality of components, or the functions of a plurality of components may be realized by one component. Part of the structure of each of the above embodiments may be omitted. At least part of the structure of each of the above embodiments may be added to or partially replace the structures of other embodiments. All modes included in the technical idea specified by the wording of the claims are embodiments of the present disclosure.

1. A fine bubble generation device that generates fine bubbles in a liquid by causing the liquid to pass through a porous element having many pores,
the fine bubble generation device comprising:
a differential pressure applying section that applies a differential pressure between first and second sides of the element; and
a bubble generating section configured such that, by the differential pressure applied by the differential pressure applying section, the liquid disposed on the first side of the element is passed through the element and is jetted toward the second side to thereby generate fine bubbles,
wherein the flow speed of the liquid during passage through the element is 0.009769 [m/s] or higher.

2. The fine bubble generation device according to claim 1, wherein the element has an average pore diameter of 1.5 μm to 500 μm.

3. The fine bubble generation device according to claim 1, wherein the element has a surface porosity of 24% to 47.7%.

4. The fine bubble generation device according to claim 1, wherein the contact angle of the liquid on a surface of the element is 38.8° to 151.32°.

5. The fine bubble generation device according to claim 1, wherein the element is formed of a ceramic.

6. The fine bubble generation device according to claim 1, further comprising:
a first tank formed integrally with the element; and
a second tank that receives the liquid jetted from the element.

7. The fine bubble generation device according to claim 6, wherein the first tank has a gas supply section serving as the differential pressure applying section so as to supply a gas to the first tank, the gas applying the differential pressure, and a liquid supply section for supplying the liquid to the first tank.

8. The fine bubble generation device according to claim 6, wherein the second tank has a liquid withdrawing section for withdrawing the jetted liquid to the outside.

9. A fine bubble generation method for generating fine bubbles in a liquid by causing the liquid to pass through a porous element having many pores,
the method comprising the step of generating the fine bubbles by applying a differential pressure between first and second sides of the element to thereby cause the liquid disposed on the first side of the element to pass through the element and be jetted toward the second side,
wherein the flow speed of the liquid during passage through the element is set to 0.009769 [m/s] or higher.
